(19) United States
(12) Patent Application Publication
(10) Pub. No.: US 2009/0051549 A1
(43) Pub. Date: Feb. 26, 2009

(54) BED LOAD DETECTOR

(75) Inventors: Masaharu Tochigi, Tochigi (JP); Kazuo Hirose, Tochigi (JP); Shingo Noguchi, Tochigi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: SHOWA DENKO K.K, Minato-ku, Tokyo (JP)

(21) Appl. No.: 11/909,216

(22) PCT Filed: Mar. 24, 2006
(86) PCT No.: PCT/JP2006/306789

§ 371 Date: Sep. 20, 2007

Related U.S. Application Data
(60) Provisional application No. 60/666,169, filed on Mar. 30, 2005.

(30) Foreign Application Priority Data
Mar. 24, 2005 (JP) 2005-85856

(51) Int. Cl. G08B 23/00

(52) U.S. Cl. 340/573.4

(57) ABSTRACT

A load detector 1 is provided with a base plate portion 2 to be disposed on a bed installation surface 55, a leg disposing plate portion 13 on which a caster 51 as a leg portion of a bed is to be disposed, the leg disposing plate portion 13 being provided at a tip end portion of a cantilever portion 7 supported generally horizontally in a state in which the leg disposing plate portion 12 is away from the bed installation surface 55, and a distortion detection sensor R attached to the cantilever portion 7, the distortion detection sensor R detecting a distortion of the cantilever portion 7 and outputting a signal to be used to detect a bed load.

This application claims priority to Japanese Patent Application No. 2005-85856 filed on Mar. 24, 2005, and U.S. Provisional Application No. 60/666,169 filed on Mar. 30, 2005, the entire disclosures of which are incorporated herein by reference in their entireties.

### CROSS REFERENCE TO RELATED APPLICATIONS

This application is an application filed under 35 U.S.C. §111(a) claiming the benefit pursuant to 35 U.S.C. §119(e)(1) of the filing date of U.S. Provisional Application No. 60/666,169 filed on Mar. 30, 2005, pursuant to 35 U.S.C. §111(b).

### TECHNICAL FIELD

The present invention relates to relates to abed load detector, a bed occupancy detecting apparatus for detecting whether a subject is occupying a bed, a bed occupancy detecting method, and a bed occupancy monitoring system.

### BACKGROUND ART

In medical facilities, aged care facilities, nursing-care facilities, etc., in order to grasp the health of subjects, such as sick persons, infants, aged persons and care recipients, a biological information measuring device for measuring biological information, such as, e.g., a body motion, a respiratory rate and a pulse rate (cardiac beats rate), of a subject occupying (staying on) a bed for sleep, rest, etc., has been developed.

Besides, as an equipment for detecting whether a subject is occupying a bed, also known is an equipment equipped with load cells attached to legs of a bed to detect a subject's occupancy and non-occupancy of the bed based on an output signal from the load cells (see, e.g., Japanese Unexamined Laid-open Patent Publication No. 2003-79585).

Furthermore, as a bed load detector to be disposed between a leg of a bed and the bed installation surface, also known is a sensor in which a sensor board equipped with a distortion sensing resistor is disposed on a substrate and a load receiving plate for causing distortion of the distortion sensing resistor in response to the load of the leg of the bed is arranged on the substrate (see, e.g., Japanese Unexamined Laid-open patent publication No. 2000-105884).

In the meantime, a bed load detector is configured to detect a bed load by disposing a bed leg on a predetermined mounting portion of the bed load detector. With this load detector, if the height of the mounting portion is high, the height of the bed surface from the bed installation surface becomes high by the height of the mounting portion. This causes difficulty of getting on and out of the bed by a subject and makes the work for putting the bed leg on and off the load detector difficult.

The description herein of advantages and disadvantages of various features, embodiments, methods, and apparatus disclosed in other publications is in no way intended to limit the present invention. Indeed, certain features of the invention may be capable of overcoming certain disadvantages, while still retaining some or all of the features, embodiments, methods, and apparatus disclosed therein.

Other objects and advantages of the present invention will be apparent from the following preferred embodiments.

### DISCLOSURE OF INVENTION

The preferred embodiments of the present invention have been developed in view of the above-mentioned and/or other problems in the related art. The preferred embodiments of the present invention can significantly improve upon existing methods and/or apparatuses.

Among other potential advantages, some embodiments can provide a bed load detector in which a height of a leg disposing plate portion for disposing a leg of a bed is kept low.

Among other potential advantages, some embodiments can provide a bed occupancy detecting apparatus equipped with the bed load detector.

Among other potential advantages, some embodiments can provide a bed occupancy detecting method using the bed load detector.

Among other potential advantages, some embodiments can provide a bed occupancy monitoring system equipped with the bed load detector.

To attain the aforementioned objects, the preferred embodiments of the present invention provide the following means.

[1] A bed load detector, comprising:

a base plate portion to be disposed on a bed installation surface;

a cantilever portion supported approximately horizontally by the base plate portion in a state in which the cantilever portion is located at a distance above the bed installation surface;

a leg disposing plate portion on which a leg portion of a bed is disposed, the leg disposing plate portion being provided at a tip end portion of the cantilever portion; and

a distortion detection sensor configured to detect distortion of the cantilever portion and output a signal to be used for detection of a bed load.

[2] The bed load detector as recited in the aforementioned item 1, wherein the base plate portion includes a pair of side portions arranged in an opposed manner at a certain distance and a connecting portion arranged between both the side portions and mutually connecting one end portions of both the side portions, and

wherein the cantilever portion is supported by the connecting portion so that the leg disposing plate portion can be displaced downwardly between both the side portions.

[3] The bed load detector as recited in the aforementioned item 1, wherein the base plate portion includes a pair of side portions arranged in an opposed manner at a certain distance and a pair of connecting portions arranged in an opposed manner at a certain distance and mutually connecting one end portions of the side portions and the other end portions of the side portions respectively, and

wherein the cantilever portion is supported by one of the connecting portions so that the leg disposing plate portion can be displaced downwardly between the side portions and the connecting portions.

[4] The bed load detector as recited in the aforementioned item 3, wherein the leg portion of the bed is provided with a bed moving caster, and

wherein a slope for guiding the caster from the bed installation surface to the leg disposing plate portion is formed on the other of the connecting portions.

[5] The bed load detector as recited in any one of the aforementioned items 1 to 4, wherein the leg disposing plate portion is provided with a leg portion fall preventing means for preventing a fall of the leg portion of the bed from the leg disposing plate portion.

[6] The bed load detector as recited in the aforementioned item 5, wherein a leg portion fall preventing wall portion upwardly protruded with respect to an upper surface of the leg disposing plate portion is provided at a basal end portion of the leg disposing plate portion as the leg portion fall preventing means.

[7] The bed load detector as recited in the aforementioned item 5 or 6, wherein a pair of leg portion fall preventing wall portions upwardly protruded with respect to an upper surface of the leg disposing plate portion are provided at both side edge portions of the leg disposing plate portion as the leg portion fall preventing means.

[8] The bed load detector as recited in the aforementioned item 7, wherein the leg portion of the bed is provided with a bed moving caster, and

wherein a convex ridge portion that the caster can climb over is provided along a tip end portion of the upper surface of the leg disposing plate portion so that the caster is positioned at a regular load detection position on the leg disposing plate portion by climbing over the convex ridge portion.

[9] The bed load detector as recited in the aforementioned item 4, wherein a leg portion fall preventing wall portion upwardly protruded with respect to an upper surface of the leg disposing plate portion is provided at a basal end portion of the leg disposing plate portion as a means for preventing a fall of the caster from the leg disposing plate portion,

Wherein a pair of leg portion fall preventing wall portions upwardly protruded with respect to an upper surface of the leg disposing plate portion are provided at both side edge portions of the leg disposing plate portion as a means for preventing a fall of the caster from the leg disposing plate portion, wherein a convex ridge portion that the caster can climb over is provided along a tip end portion of the upper surface of the leg disposing plate portion so that the caster is positioned at a regular load detection position on the leg disposing plate portion by climbing over the convex ridge portion, and

wherein a front face of the convex ridge portion is formed into a slant face of a rising gradient larger than a gradient of the slope formed on the other of the connecting portions in a traveling direction of the caster at the time of disposing the caster from the bed installation surface onto the leg disposing plate portion.

[10] The bed load detector as recited in the aforementioned item 3, wherein the leg portion of the bed is provided with a bed moving caster,

wherein a pair of caster fall prevention wall portions protruded upwardly with respect to the upper surface of the leg disposing plate portion are provided at both side edge portions of the leg disposing plate portion as a means for preventing a fall of the caster from the leg disposing plate portion so that a distance of the caster fall prevention wall portions increases in a direction opposite to a traveling direction of the caster at the time of disposing the caster from the bed installation surface onto the leg disposing plate portion, and

wherein a stopper wall portion upwardly protruded with respect to the upper surface of the leg disposing plate portion for stopping a travel of the caster which arrived at a regular load detection position on the leg disposing plate portion is provided at a basal end portion of the leg disposing plate portion.

[11] The bed load detector as recited in the aforementioned item 10, wherein a slope for guiding the caster from the bed installation surface to the leg disposing plate portion is formed on the other of the connecting portions.

[12] The bed load detector as recited in the aforementioned item 10 or 11, wherein a convex ridge portion that the caster can climb over is provided along a tip end portion of the upper surface of the leg disposing plate portion so that the caster is positioned at the regular load detection position on the leg disposing plate portion by climbing over the convex ridge portion.

[13] The bed load detector as recited in the aforementioned item 11, wherein a convex ridge portion that the caster can climb over is provided along a tip end portion of the upper surface of the leg disposing plate portion so that the caster is positioned at the regular load detection position on the leg disposing plate portion by climbing over the convex ridge portion, and

wherein a front face of the convex ridge portion is formed into a slant face of a rising gradient larger than a gradient of the slope formed on the other of the connecting portions in a traveling direction of the caster at the time of disposing the caster from the bed installation surface onto the leg disposing plate portion.

[14] The bed load detector as recited in any one the aforementioned items 1 to 13, wherein at least tip end portion of the upper surface of the leg disposing plate portion is formed into a slant face of a falling gradient in a direction from the tip end portion of the leg disposing plate portion toward the basal end side thereof.

[15] The bed load detector as recited in any one the aforementioned items 1 to 14, wherein at least tip end portion of a lower surface of the leg disposing plate portion is formed into a slant face of a falling gradient in a direction from the tip end portion of the leg disposing plate portion toward the basal end side thereof.

[16] The bed load detector as recited in any one the aforementioned items 1 to 15, wherein an elastic nonslip member is disposed in a dented portion formed in a floor contacting face which comes into contact with the bed installation surface with the nonslip member protruded downwardly from the floor contacting face, and

wherein, in a state in which the nonslip member is disposed on the bed installation surface,

when the leg portion of the bed is not disposed on the leg disposing plate portion, the floor contacting face is raised from the bed installation surface at a distance by being supported by the nonslip member,

while when the leg portion of the bed is disposed on the leg disposing plate portion, the nonslip member is compressed between a ceiling surface of the dented portion and the bed installation surface by a load from the leg portion of the bed and the floor contacting face comes into contact with the bed installation surface.

[17] The bed load detector as recited in the aforementioned item 16, wherein the dented portion is formed at three or more portions surrounding a portion immediately below a regular load detection position on the leg disposing plate portion in the floor contacting face, respectively, and wherein the nonslip member is disposed in each of the dented portions.

[18] The bed load detector as recited in the aforementioned item 16 or 17, wherein a size of the dented portion is set so that the dented portion can accommodate the entirety of the nonslip member in a condition in which the nonslip member is compressed between the ceiling face of the dented portion and the bed installation surface.

[19] The bed load detector as recited in any one of the aforementioned items 16 to 18, wherein the nonslip member is made of rubber.

[20] The bed load detector as recited in any one of the aforementioned items 1 to 19, wherein a strain gage is equipped to the cantilever portion as the distortion detection sensor.

[21] The bed load detector as recited in the aforementioned item 20, wherein an electric output from a bridge circuit including the strain gage is used to detect a bed load.

[22] The bed load detector as recited in any one the aforementioned items 1 to 21, wherein at least one of the base plate portion, the cantilever portion and the leg disposing plate portions is an extruded article.

[23] The bed load detector as recited in any one of the aforementioned items 1 to 21, wherein at least two of the base plate portion, the cantilever portion and the leg disposing plate portions are integrally formed by aluminum die casting.

[24] A bed occupancy detecting apparatus, comprising:

the bed load detector as recited in any one the aforementioned items 1 to 23; and

an operation means configured to calculate whether a subject is occupying a bed based on an output signal from the distortion detection sensor of the bed load detector.

[25] The bed occupancy detecting apparatus as recited in the aforementioned item 24, further comprising a display means for displaying an operation result of the operation means.

[26] The bed occupancy detecting apparatus as recited in the aforementioned item 24 or 25, further comprising an alarm means for giving an alarm based on an operation result of the operation means.

[27] The bed occupancy detecting apparatus as recited in any one the aforementioned items 24 to 26, further comprising a communication means for transmitting an operation result by the operation means.

[28] A bed occupancy detecting method, comprising:

disposing the bed load detector as recited in any one the aforementioned items 1 to 23 on a bed installation surface;

disposing a leg portion of a bed on the leg disposing plate portion of the load detector; and

in this condition, detecting whether a subject is occupying the bed using an output signal from the distortion detection sensor of the bed load detector.

[29] A bed occupancy monitoring system, comprising:

the bed load detector as recited in any one the aforementioned items 1 to 23;

an operation means for calculating whether a subject is occupying the bed based on an output signal from the distortion detection sensor of the bed load detector;

a display means for displaying an operation result of the operation means;

an alarm means for giving an alarm based on an operation result of the operation means; and

a communication means for transmitting the operation result of the operation means.

The invention causes the following effects.

With the invention as recited in the aforementioned item 1, the load detector can be simplified in structure, and therefore the height of the leg disposing plate portion of the load detector can be lowered.

With the invention as recited in the aforementioned item 2, no base plate portion exists at the bottom side of the leg disposing plate portion, and therefore the height of the leg disposing plate portion can be further lowered.

With the invention as recited in the aforementioned item 3, like the invention of the aforementioned item 2, no base plate portion exists at the bottom side of the leg disposing plate portion, and therefore the height of the leg disposing plate portion can be further lowered. Furthermore, since one end portions and the other end portions of both the side portions of the base plate portion are mutually connected by the connecting portion, respectively, the stability of the base plate portion is high, and therefore the leg disposing plate portion can be displaced downwardly correctly. This enables correct detection of the load.

With the invention as recited in the aforementioned item 4, at the time of disposing the caster as a leg portion of a bed from a bed installation surface to the leg disposing plate portion, by making the caster pass over the slope of the other of the connecting portions, the caster can be easily disposed on the leg disposing plate portion.

With the invention as recited in the aforementioned item 5, it is possible to prevent the leg portion of the bed from falling from the leg disposing plate portion.

With the invention as recited in the aforementioned item 6, it is possible to assuredly prevent the leg portion of the bed from falling from the leg disposing plate portion.

With the invention as recited in the aforementioned item 7, it is possible to assuredly prevent the leg portion of the bed from falling from the leg disposing plate portion.

With the invention as recited in the aforementioned item 8, the caster as a leg portion of a bed can be assuredly disposed on the regular load detection position of the leg disposing plate portion. Furthermore, an unexpected fall of the caster disposed on the leg disposing plate portion from the tip end portion of the leg disposing plate portion can be prevented by the convex ridge portion.

With the invention as recited in the aforementioned item 9, it is possible to assuredly prevent the leg portion of the bed from falling from the leg disposing plate portion. The caster can be assuredly disposed on the regular load detection position of the leg disposing plate portion. Furthermore, an unexpected fall of the caster disposed on the leg disposing plate portion from the tip end portion of the leg disposing plate portion can be prevented by the convex ridge portion. Furthermore, since the front face of the convex ridge portion is formed into a slant face of a rising gradient larger than the gradient of the slope in the traveling direction of the caster, a person who is moving the bed can easily discriminate based on the pushing force on whether the caster climbed over the convex ridge portion from the slope, or whether the caster is disposed on the regular load detection position of the leg disposing plate portion.

With the invention as recited in the aforementioned item 10, since the pair of caster fall prevention wall portions are provided at both side edge portions of the leg disposing plate portion, at the time of disposing the caster as the leg portion of the bed on the leg disposing plate portion from the bed installation surface, a fall of the caster from the leg disposing plate portion can be prevented. Furthermore, both the caster fall prevention wall portions are provided such that the distance therebetween becomes larger in a direction opposite to the traveling direction of the caster. Therefore, at the time of disposing the caster on the leg disposing plate portion, the caster can be easily put between the caster fall prevention wall portions on the leg disposing plate portion, which in turn enables an easy installation of the caster. Furthermore, since the stopper wall portion for preventing the moving of the caster which arrived at the regular load detection position on the leg disposing plate portion is provided at the basal end portion of the leg disposing plate portion, the caster can be certainly disposed on the regular load detection position of the leg disposing plate portion.

With the invention as recited in the aforementioned item 11, at the time of disposing the caster on the leg disposing plate portion from the bed installation surface, the caster can be easily disposed on the leg disposing plate portion by running on the slope of the other of the connecting portions.

With the invention as recited in the aforementioned item 12, the caster can be certainly disposed on the regular load detection position of the leg disposing plate portion. Furthermore, an unexpected fall of the caster disposed on the leg disposing plate portion from the tip end portion of the leg disposing plate portion can be prevented by the convex ridge portion.

With the invention as recited in the aforementioned item 13, the caster can be certainly disposed on the regular load detection position of the leg disposing plate portion. Furthermore, an unexpected fall of the caster disposed on the leg disposing plate portion from the tip end portion of the leg disposing plate portion can be prevented by the convex ridge portion. Furthermore, the front face of the convex ridge portion is formed into a slant face of a rising gradient larger than the gradient of the slope in the traveling direction of the caster. Therefore, a person who moves the bed can discriminate based on the bed pushing force on whether the caster climbed over the convex ridge portion, i.e., whether the caster is disposed on the regular load detection position of the leg disposing plate portion.

With the invention as recited in the aforementioned item 14, a fall of the leg portion of the bed from the tip end portion of the leg disposing plate portion can be prevented.

With the invention as recited in the aforementioned item 15, the distance from the bed installation surface to the tip end portion of the leg disposing plate portion can be increased. Therefore, it becomes possible to prevent the tip end portion of the leg disposing plate portion from coming into contact with the bed installation surface due to the downward movement of the leg disposing plate portion as small as possible.

With the invention as recited in the aforementioned item 16, in a state in which the load detector is disposed on the bed installation surface, when the leg portion of the bed is not disposed on the leg disposing plate portion, the floor contacting face of the load detector is raised from the bed installation surface by being supported by the nonslip member. Therefore, at the time of disposing the leg portion of the bed on the leg disposing plate portion, the slip of the load detector on the bed installation surface can be prevented by the nonslip member. Furthermore, when the leg portion of the bed is disposed on the leg disposing plate portion, the nonslip member is compressed between the ceiling face of the dented portion and the bed installation surface by the load from the leg portion of the bed and the floor contacting face comes into contact with the bed installation surface. Therefore, the deterioration of the detection accuracy of the load due to the influence of the nonslip member can be prevented. Furthermore, since the force for pressing the nonslip member against the bed installation surface is decreased, even if the nonslip member is made of rubber, adhesion of the nonslip member to the installation surface can be restrained.

With the invention as recited in the aforementioned item 17, the stability of the load detector can be improved in a condition in which the leg portion of the bed is disposed on the regular load detection position of the leg disposing plate portion.

With the invention as recited in the aforementioned item 18, when the nonslip member is compressed, the nonslip member can be assuredly accommodated in the dented portion. Consequently, in a state in which the leg portion of the bed is disposed on the leg disposing plate portion, the floor contacting face of the load detector can be assuredly brought into contact with the bed installation surface.

With the invention as recited in the aforementioned item 19, since the nonslip member made of rubber can generally be obtained cheaply, the manufacturing cost of the load detector can be reduced by using the nonslip member made of rubber.

With the invention as recited in the aforementioned item 20, the distortion of the cantilever portion can be detected assuredly.

With the invention as recited in the aforementioned item 21, the distortion of the cantilever portion can be detected with high accuracy.

With the invention as recited in the aforementioned item 22, at least one of the base plate portion, the cantilever portion and the leg disposing plate portion can be advantageously manufactured in cost.

With the invention as recited in the aforementioned item 23, at least two of the base plate portion, the cantilever portion and the leg disposing plate portion can be advantageously manufactured in cost, and the connecting strength therebetween can be increased.

With the invention as recited in the aforementioned item 24, the aforementioned effects of the invention as recited in any one of the aforementioned items 1 to 23 can be obtained, and it is possible to certainly detect whether the subject is occupying the bed.

With the invention as recited in the aforementioned item 25, the operation result of the operation means can be displayed certainly.

With the invention as recited in the aforementioned item 26, in cases where the operation result of the operation means falls outside the set range, an alarm can be given to a nurse, a care worker, a guard, etc.

With the invention as recited in the aforementioned item 27, it is detectable whether the subject is occupying the bed at a remote place.

With the invention as recited in the aforementioned item 28, the above effect of the invention as recited in any one of the aforementioned items 1 to 23 can be obtained. Furthermore, it is possible to certainly detect whether the subject is occupying the bed.

With the invention as recited in the aforementioned item 29, the above effects of the invention as recited in any one of the aforementioned items 1 to 23 can be obtained. Furthermore, it is possible to certainly monitor whether the subject is occupying the bed.

### BRIEF DESCRIPTION OF DRAWINGS

The preferred embodiments of the present invention are shown by way of example, and not limitation, in the accompanying figures, in which:

FIG. 1 is a schematic perspective view showing a bed load detector and a bed occupancy detecting apparatus in use according to a first embodiment of the invention;

FIG. 2 is an enlarged view of the portion A in FIG. 1;

FIG. 3 is a perspective view of the load detector;

FIG. 4 is a plan of the load detector;

FIG. 5 is a cross-sectional view taken along the line X-X in FIG. 4;

FIG. 6 is an exploded perspective view of the load detector;

FIG. 7A is a side view showing a cantilever portion of the load detector;

FIG. 7B is a bottom view of the cantilever portion;

FIG. 8 shows a bridge circuit of the load detector;

FIG. 9 is a block diagram of the occupancy sensing device;

FIG. 10 is a flowchart showing occupancy detecting processing of the bed occupancy detecting apparatus;

FIG. 11 is a graph showing a relationship between a standard set value for an occupancy judgment and a standard set value for a non-occupancy judgment in the bed occupancy detecting apparatus;

FIG. 12 is a perspective view showing a bed load detector according to a second embodiment of the invention;

FIG. 13 is a plan of the load detector;

FIG. 14 is a cross-sectional view taken along the line X-X in FIG. 13;

FIG. 15 is an exploded perspective view of the load detector;

FIG. 16 is a perspective view of a bed load detector according to a third embodiment of the invention;

FIG. 17 is a plan of the load detector;

FIG. 18 is a bottom view of the load detector;

FIG. 19 is a cross-sectional view taken along the line X-X in FIG. 17;

FIG. 20 is an enlarged view of the portion Z in FIG. 19;

FIG. 21 is an exploded perspective view of the load detector;

FIG. 22 is a partially broken side view showing the state before disposing a caster of a bed on a leg disposing plate portion of the load detector;

FIG. 23 is an enlarged view of the portion Y in FIG. 22;

FIG. 24 is a partially broken side view in the state in which the caster of the bed is disposed on the leg disposing plate portion of the load detector; and

FIG. 25 is an enlarged view of the portion Y in FIG. 24.

### BEST MODE FOR CARRYING OUT THE INVENTION

In the following paragraphs, some preferred embodiments of the invention will be described by way of example and not limitation. It should be understood based on this disclosure that various other modifications can be made by those in the art based on these illustrated embodiments.

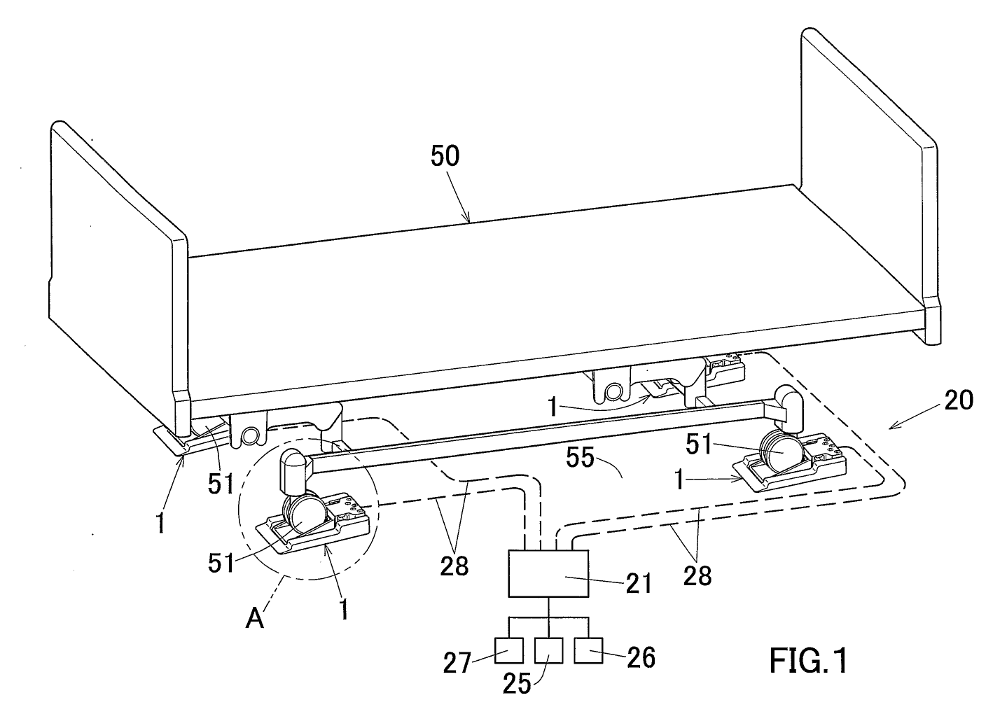

In FIG. 1, the reference numeral “1” denotes a bed load detector according to a first embodiment of the invention, and the reference numeral “20” denotes a bed occupancy detecting apparatus according to an embodiment of the invention. And, the reference numeral “50” denotes a bed.

The bed 50 is used at medical facilities (e.g., hospitals), aged person institutions, nursing-care facilities, ordinary homes, etc., and is formed into a rectangular shape as seen from the top. This bed 50 has a plurality of leg portions. Specifically, it has a total of four leg portions, i.e., a leg portion located at the left side of a head of a subject (not shown), a leg portion located at the light side of the head of the subject, a leg portion located at the side of the left leg of the subject, and a leg portion located at the side of the right leg of the subject. In this embodiment, each leg portion of the bed 50 is provided with a rotatable bed moving caster 51 for running on a bed installation surface 55 at the time of moving the bed 50.

On this bed 50, a healthy person, a sick person, an infant, an aged person, or a care recipient, etc., as a subject occupies in a lying-down posture or the like for sleep, rest, etc.

It should be noted that in this invention the bed 50 is not limited to the aforementioned bed for sleeping or resting, but can be, e.g., an examination table, an inspection bench, a stretcher, or a sofa.

The bed occupancy detecting apparatus 20 is designed to detect whether a subject is occupying the bed 50.

The bed load detector 1 of this embodiment is used in the aforementioned occupancy detecting apparatus 20. More specifically, the bed load detector 1 is used so as to be disposed under each of the total four casters 51, 51, 51 and 51 as a plurality of leg portions of the bed 50 on the bed installation surface 55. In other words, the bed load detector 1 is used by being disposed between the bed installation surface 55 and each caster 51 of a bed 50. The bed installation surface 55 includes a floor of, e.g., a hospital room, a consultation room, an inspecting room, a bedroom, etc.

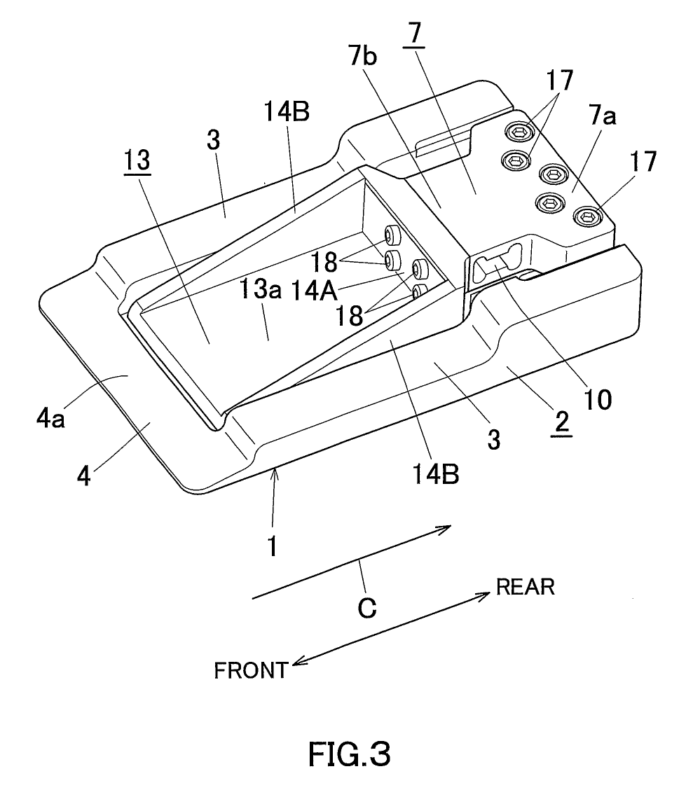

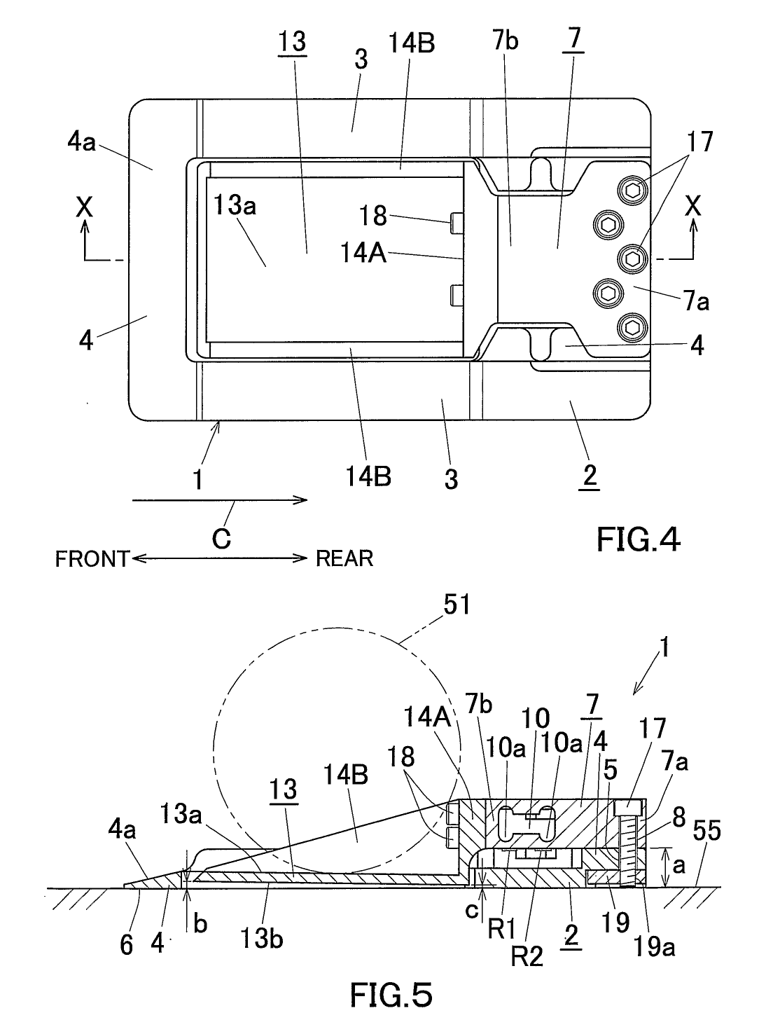

For easy of explanation, in this embodiment, in a state in which the load detector 1 is disposed on the bed installation surface 55, the direction along the length direction of the bed 50 is called as a longitudinal direction of the load detector 1 or its component, and the direction along the widthwise direction of the bed 50 is called as a widthwise direction of the load detector 1 and its component. In this embodiment, it is assumed that a load of a maximum 2000 N (200 kgf) is applied to one load detector 1. In FIGS. 3 and 4, the front and rear directions of the load detector 1 is shown by arrows.

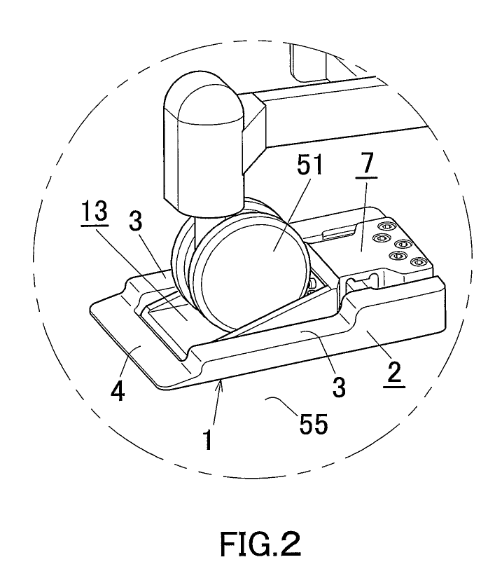

As shown in FIGS. 1 to 7B, the load sensor 1 is equipped with a base plate portion 2, a cantilever portion 7, a leg disposing plate portion 13, and strain gages R1, R2, R3 and R4 as distortion detection sensors.

The base plate portion 2 is made of an extruded material of aluminum (including its alloy; hereinafter simply referred to as aluminum), and is to be disposed on the bed installation surface 55.

As shown in FIGS. 3, 4, and 6, this base plate portion 2 is comprised of a pair of side portions 3 and 3 opposed with each other at a distance, and a pair of connecting portions 4 and 4 disposed between the side portions 3 and 3 and connecting one end portions and other end portions of the side portions 3 and 3, respectively, and formed into a generally rectangular shape. In this embodiment, the side portions 3 and 3 are disposed apart from each other in the widthwise direction of the base plate portion 2 (i.e., the widthwise direction of the bed 50). The connecting portions 4 and 4 are disposed apart from each other in the longitudinal direction of the base plate portion 2 (i.e., the longitudinal direction of the bed 50).

In FIG. 5, the reference numeral “6” denotes a floor contacting face of the load detector 1 which comes into contact with the bed installation surface 55. This floor contacting face 6 is a lower surface of the base plate portion 2.

As shown in FIG. 5, the thickness “a” of the connecting portion 4 of the base plate portion 2 is determined in consideration of a modulus of section, etc. so that the base plate portion 2 will not be deformed when the caster 51 of the bed 50 is disposed. Furthermore, it is preferable that the height is set to a height which does not interfere with any portions other than the caster 51 of the bed 50. For example, the height is preferably set to 70 mm or less, more preferably 40 mm or less. In this invention, however, it is not limited that the thickness “a” falls within the aforementioned range.

The cantilever portion 7 is a straight aluminum extruded article with a certain length which functions as an elastically deformable strain generation member. This cantilever portion 7 is supported generally horizontally by the base plate portion 2 in a cantilever manner in a state in which the cantilever portion 7 is slightly upwardly away from the bed installation surface 55 and extending in the longitudinal direction between both the side portions 3 and 3. In details, the basal end portion (i.e., fixed end portion) 7a of this cantilever portion 7 is disposed on one of the connecting portions 4 and 4 of the base plate portion 2. With this disposed state, the basal end portion 7a of the cantilever portion 7 is fixed to the connecting portion 4 with a plurality of (5 in this embodiment) cantilever portion fixing bolts 17 (or screws). Furthermore, in this fixed state, the cantilever portion 7 is horizontally disposed between the side portions 3 and 3 and supported by the connecting portion 4.

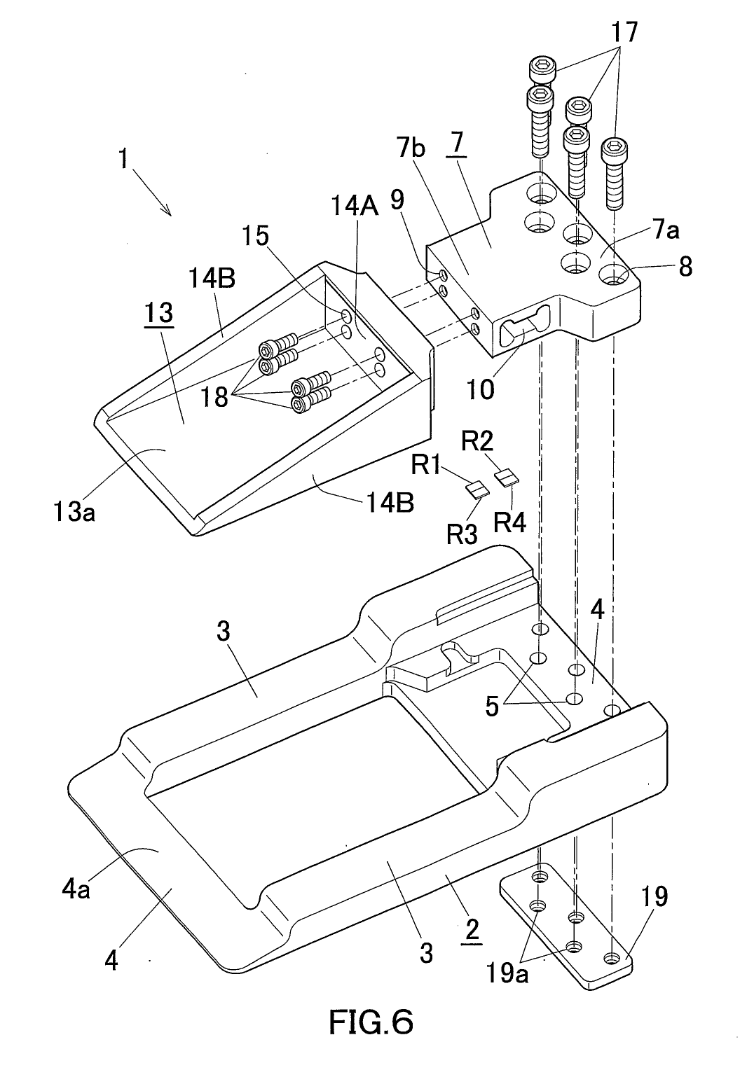

In FIG. 6, the reference numeral “8” denotes a bolt insertion hole (or screw insertion hole) formed in the basal end portion 7a of the cantilever portion 7 corresponding to the cantilever portion fixing bolt 17 (or screw). The reference numeral “5” denotes a bolt insertion hole (or screw insertion hole) formed in the connecting portion 4 corresponding to the cantilever portion fixing bolt 17 (or screw). The reference numeral “19” denotes a screw hole plate having a screw hole 19a corresponding to the cantilever portion fixing bolt 17. This screw hole plate 19 is arranged in the dented portion formed on the lower surface of the connecting portion 4 as shown in FIG. 5.

It should be noted that in this invention the fixing means of the cantilever portion 7 to the base plate portion 2 is not limited to a bolt 17, and can be, for example, a screw, a rivet, welding, friction agitation welding, or brazing.

The leg disposing plate portion 13 is an aluminum extruded article, and a caster 51 as a leg portion of a bed 50 is disposed on the upper surface 13a of this leg disposing plate portion 13. This leg disposing plate portion 13 is attached to the tip end portion (i.e., free end) 7b of the cantilever portion 7 in a generally horizontal manner. In detail, to the basal end portion of this leg disposing plate portion 13, as a caster fall preventing means (i.e., leg portion fall preventing means) for preventing the fall of the caster 51 (i.e., leg portion of the bed) from the leg disposing plate portion 13, a caster fall prevention wall portion 14A (i.e., leg portion fall preventing wall portion) upwardly protruded with respect to the upper surface 13a of the leg disposing plate portion 13 is fixedly attached. This caster fall prevention wall portion 14A also has a function as a stopper wall portion which stops the travel of the caster 51 which arrived at the regular load detection position on the leg disposing plate portion 13 from the bed installation surface 55. Therefore, this caster fall prevention wall portion 14A can also be regarded as a stopper wall portion.

At the right and left side edge portions of the leg disposing plate portion 13, as a caster fall preventing means (i.e., leg portion fall preventing means), a pair of right and left caster fall prevention wall portions 14B and 14B (i.e., leg portion fall preventing wall portions) upwardly protruded with respect to the upper surface 13a of the leg disposing plate portion 13 are fixedly provided. In this first embodiment, both the caster fall prevention wall portions 14B and 14B are arranged in parallel with each other. On the other hand, such a caster fall prevention wall portion is not provided at the tip end portion of the leg disposing plate portion 13.

In FIGS. 3 and 4, the reference letter “C” denotes a traveling direction of the caster 51 at the time of disposing the caster 51 from the bed installation surface 55 to the leg disposing plate portion 13.

In this leg disposing plate portion 13, as shown in FIG. 5, the caster fall prevention wall portion 14A of the basal end portion of this leg disposing plate portion 13 is fitted on the tip end face which is a vertical face of the tip end portion 7b of the cantilever portion 7 in a state in which the lower surface 13b of the leg disposing plate portion 13 is positioned slightly lower than the lower surface of the cantilever portion 7. In this fitting state, by fixing the caster fall prevention wall portion 14A to the tip end face of the cantilever portion 7 with a plurality of leg disposing plate portion fixing screws (4 screws in this embodiment) 18, the leg disposing plate portion 13 is fixed to the tip end portion 7b of the cantilever portion 7 in a generally horizontal manner with the leg disposing plate portion 13 slightly upwardly away from the bed installation surface 55 between the side portions 3 and 3 and the connecting portions 4 and 4 of the base plate portion 2.

As will be apparent from the above, the cantilever portion 7 is supported by the connecting portion 4 so that the leg disposing plate portion 13 can be downwardly displaced between the side portions 3 and 3 and the connecting portions 4 and 4 of the base plate portion 2.

In FIG. 6, the reference numeral “15” denotes a screw insertion hole formed in the caster fall prevention wall portion 14A of the basal end portion of the leg disposing plate portion 13 corresponding to the leg disposing plate portion fixing screw 18. And, the reference numeral “9” denotes a screw hole formed in the tip end face of the tip end portion 7b of the cantilever portion 7 corresponding to the leg disposing plate portion fixing screw 18.

It should be noted that in this invention the attaching means of the leg disposing plate portion 13 to the cantilever portion 7 is not limited to a screw 18, and can be, for example, a bolt, a rivet, welding, friction agitation welding, or brazing.

Furthermore, as shown in FIG. 5, the entire upper surface 13a of the leg disposing plate portion 13 is formed into a slant face of a slightly falling gradient in the direction from the tip end portion of the leg disposing plate portion 13 to the basal end side thereof, or in the traveling direction C of the caster 51 at the time of disposing a caster 51 from the bed installation surface 55 to the leg disposing plate portion 13. Furthermore, the entire lower surface 13b of the leg disposing plate portion 13 is formed into a slant face of a slightly falling gradient in the direction from the tip end portion of the leg disposing plate portion 13 to the basal end side thereof. As a result, in a state in which the base plate portion 2 is disposed on the bed installation surface 55, the distance “b” from the tip end portion of the lower surface 13a of the leg disposing plate portion 13 to the bed installation surface 55 is kept larger than the case in which the lower surface 13b of the leg disposing plate portion 13 is not formed into the slant face, or the lower surface 13b of the leg disposing plate portion 13 is horizontal. This distance “b” is preferably set to 1 to 10 mm or less, more preferably 1 to 5 mm or less. It should be noted that in this invention, however, the distance “b” is not limited to such a range. The distance “c” from the bed installation surface 55 to the basal end portion of the lower surface 13b of the leg disposing plate portion 13 is preferably set so as to fall within the range of from 1 to 9 mm, more preferably 1 to 4 mm. It should be noted that in this invention, however, the distance “c” is not limited to such a range. This enables fall prevention of the caster 51 from the leg disposing plate portion 13.

The angle of inclination of the upper surface 13a of the leg disposing plate portion 13 to the horizontal plane (bed installation surface 55) (i.e., gradient) is preferably set so as to fall within the range of 0.1 to 2°, more preferably 0.5 to 1°. Furthermore, the angle of inclination of the lower surface 13a of the leg disposing plate portion 13 to the horizontal plane (bed installation surface 55) (i.e., gradient) is preferably set so as to fall within the range of 0.1 to 2°, more preferably 0.5 to 1°. It should be noted that in this invention, however, these angles are not limited to such ranges.

In addition, in this invention, not the entire upper surface 13a but only the tip end portion of the upper surface 13 of the leg disposing plate portion 13 can be formed into a slant face. And, not the entire lower surface 13b but only the tip end portion of the lower surface 13b of the leg disposing plate portion 13 can be formed into a slant face.

The wall thickness of the leg disposing plate portion 13 is preferably set to 3 to 20 mm or less, more preferably 3 to 10 mm or less. It should be understood that in this invention, however, the thickness of the leg disposing plate portion 13 is not limited to such a range.

The tip end portion of the leg disposing plate portion 13 is located at the vicinity of the inner side edge portion of the other of the connecting portions 4 and 4 of the base plate portion 2.

In this invention, emboss processing can be executed to a part or the entirety of the upper surface 13a of the leg disposing plate portion 13 to prevent the slip of the caster 51.

On the other hand, on the other connecting portion 4 of the base plate portion 2, a slope 4a for guiding a caster 51 of a bed 50 to the leg disposing plate portion 13 is formed. That is, the upper surface of the other connecting portion 4 is formed into a slope 4a of a rising gradient in the direction towards the leg disposing plate portion 13. The caster 51 goes through (travels) this slope 4a to be disposed on the leg disposing plate portion 13. The gradient of the slop 4a with respect to the bed installation surface 55 preferably falls within the range of, e.g., 2 to 10°, more preferably 2 to 6°. In this invention, however, the gradient is not limited to this range.

Four strain gages R1, R2, R3 and R4 as distortion detection sensors are attached to the cantilever portion 7 to detect the distortion of the cantilever portion 7 due to the occupancy of the bed 50 by a subject to thereby output an electric signal to be used for detecting the load of the bed 50 at the time of occupancy of the bed by a subject or the load of the bed 50 at the time of non-occupancy of the bed. This output signal is used for detecting whether a subject is occupying the bed 50 in an operation means 21 which will be mentioned later.

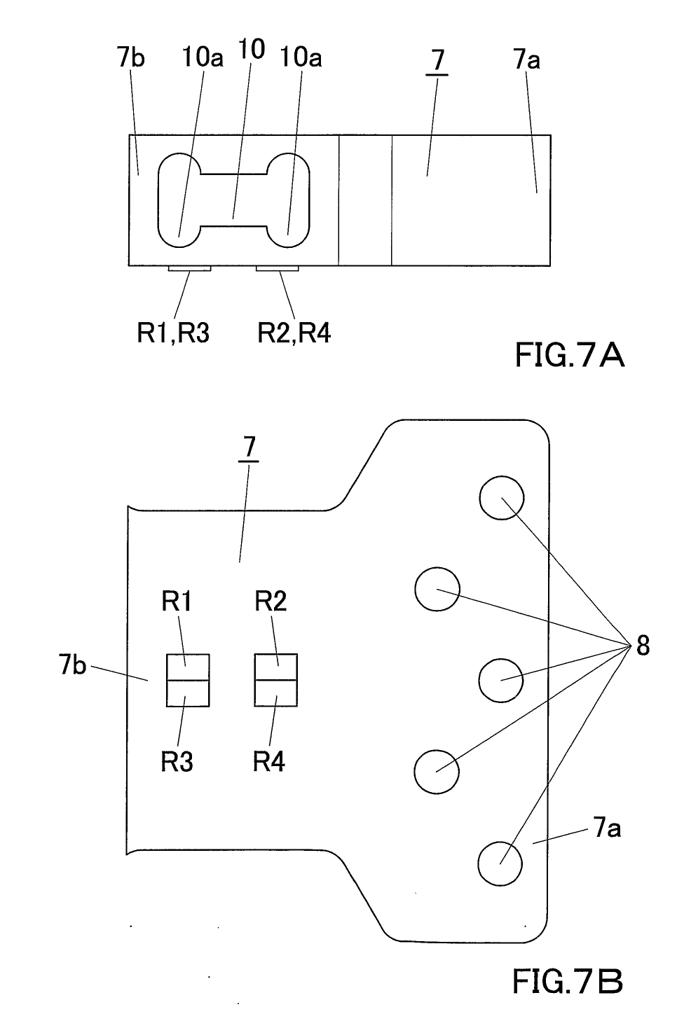

On the other hand, as shown in FIG. 7, a through-hole 10 of a eyeglasses-shape in cross-section is penetrated through the cantilever portion 7 in the widthwise direction. At a position of the lower surface of the cantilever portion 7 located below the large diameter hole portion 10a positioned at the tip end side (free end side) of the cantilever portion among the two large diameter hole portions 10a and 10a of the through-hole 10, two strain gages R1 and R3 among the four strain gages R1, R2, R3 and R4 are attached side by side with adhesive as tension side strain gages. On the other hand, at a position of the lower surface of the cantilever portion 7 located below the large diameter hole portion 10a positioned at the basal end side (fixing end side) of the cantilever portion 7, the remaining two strain gages R2 and R4 are attached side by side with adhesive as compression side strain gages.

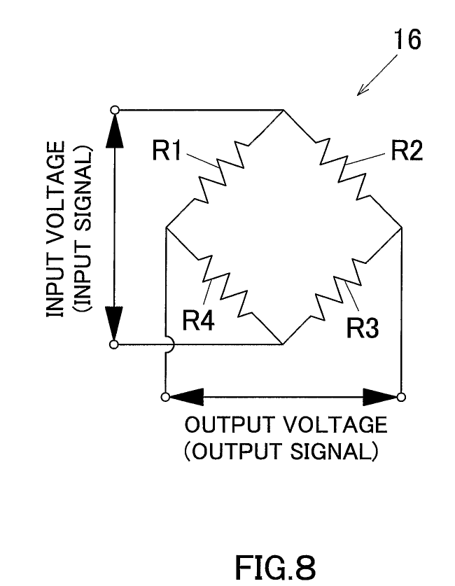

As shown in FIG. 8, these four strain gages R1, R2, R3 and R4 are electrically connected to form a Wheatstone bridge circuit 16. In this embodiment, the output voltage as an electric output signal from this bridge circuit 16 is used to detect whether a subject is occupying the bed 50.

In this embodiment, even if a caster 51 is disposed on any portion of the leg disposing plate portion 13, the distortion can be correctly detected.

As shown in FIG. 1, the bed occupancy detection apparatus 20 of this embodiment is equipped with the aforementioned four load detectors 1, 1, 1 and 1, an operation means 21, a display means 25, an alarm means 26 and a communication means 27.

The operation means 21 calculates to discriminate whether a subject is occupying the bed 50 based on the output signal from the distortion detection sensor of the load detector 1, and is constituted by a computer equipped with a CPU and memories such as a ROM and a RAM. In this embodiment, the output voltage from the bridge circuit 16 is used as an output signal from the distortion detection sensor of the load detector 1.

The display means 25 displays the operation result of the operation means 21, and has a CRT, a liquid crystal display, etc.

The alarm means 26 gives an alarm based on the operation result of the operation means 21, and has a speaker, a lamp, etc.

The communication means 27 transmits the operation result of the operation means 21.

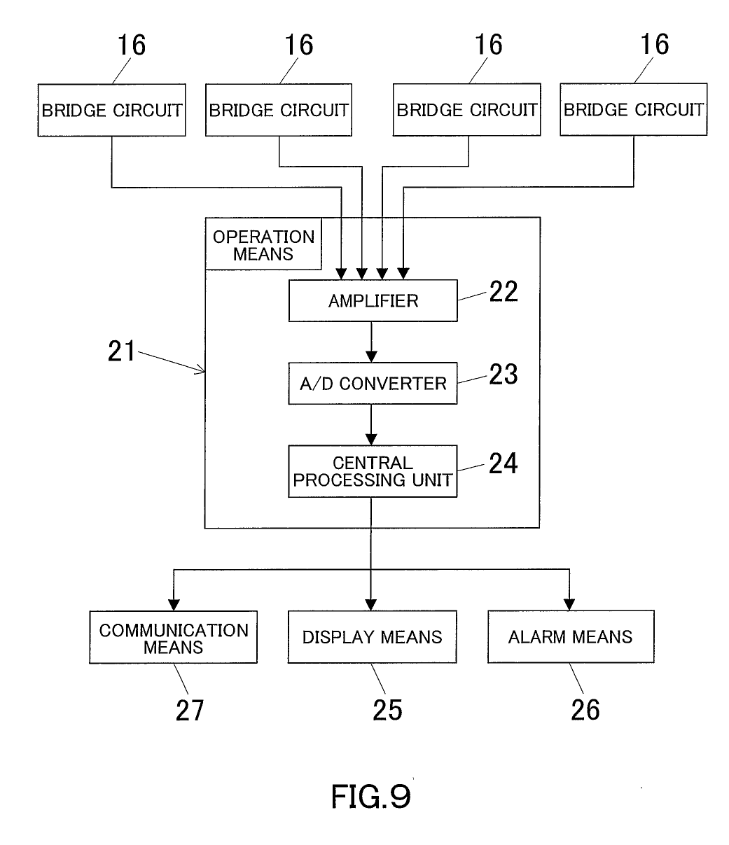

In the operation means 21, as shown in FIG. 9, after the output voltage as an output signal from the bridge circuits 16, 16, 16 and 16 of each load detector 1 is amplified with the amplifier 22, it is converted into a digital signal at the A/D converter (Analog/Digital converter) 23. Then, this signal is transmitted to the central processing unit 24, such as a computer. In the central processing unit 24, it is calculated whether based on this transmitted digital signal, a subject is occupying the bed 50 according to the predetermined program.

In this invention, the central processing unit 24 of the operation means 21 further can calculate to detect the position of the center of gravity of the subject (i.e., subject's occupancy position) on the bed 50 or can calculate to predict the falling of the subject from the bed 50.

The display means 25 displays the information on whether the subject is occupying the bed 50 as the operation result by the operation means 21 on the display such as a prescribed monitor television in real time.

With the communication means 27, the information on whether or not the subject is occupying the bed 50 as the operation result by the operation means 21 is transmitted to, for example, a monitor room such as a nursing center or a cellular phone (including PHS) as a remote place via a predetermined cable-communication network or a wireless-communication network, such as, e.g., a telephone network, the Internet, a cable LAN, a wireless LAN.

With the alarm means 26, when the information on whether the subject is occupying the bed 50 comes outside the set range as the operation result by the operation means 21, for example, when the subject occupying the bed 50 gets off the bed 50, an alarm is given to a nurse, a care worker, a guard, etc.

Now, a bed occupancy detection method carried out using the aforementioned load detector 1 and the aforementioned occupancy detecting apparatus 20 will be explained below.

Initially, as shown in FIG. 1, load detectors 1, 1, 1 and 1 are disposed at positions corresponding to the four casters 51, 51, 51 and 51 of the bed 50 on the bed installation surface 55. Subsequently, each caster 51 of the bed 50 is disposed on the leg disposing plate portion 13 of the corresponding load detector 1 from the bed installation surface 55. At this time, the caster 51 can be easily disposed on the leg disposing plate portion 13 by passing (advancing) the caster 51 on the slope 4a of the connecting portion 4 of the base plate portion 2 of the load detector 1.

Subsequently, a subject gets onto the bed 50 and lies down. When the subject occupies the bed 50 in this way, the leg disposing plate portion 13 of each load detector 1 receives the load of the bed 50 through the corresponding caster 51 and causes a downward displacement between the side portions 3 and 3 and the connecting portions 4 and 4 of the base plate portion 2. As a result, the cantilever portion 7 is elastically bent slightly downward to be distorted. This distortion is detected by the bridge circuit 16 having four strain gages R1, R2, R3 and R4 as distortion detection sensors. And the output voltage as an electric output signal from each bridge circuit 16 is transmitted to the operation means 21 through a signal line 28. Based on this transmitted output voltage, it is calculated to discriminate whether the subject is occupying the bed 50 with the operation means 21.

The operation result of the operation means 21, i.e., the information on whether the subject is occupying the bed 50 is displayed by the display means 25, and transmitted to a predetermined remote place or a predetermined cellular phone via the communication means 27. When the subject who was occupying the bed 50 gets off the bed 50, an alarm is given by the alarm means 26.

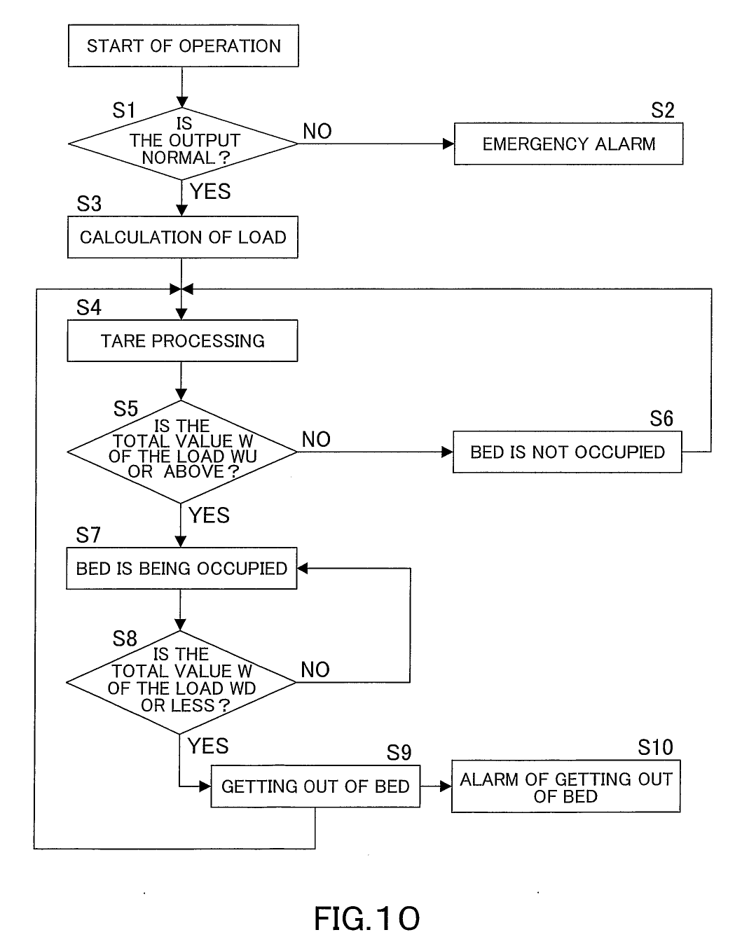

Next, the processing to be performed by the central processing unit 24 of the operation means 21 will be explained below with reference to FIG. 10.

At Step S1, immediately after the startup, it is discriminated whether the output voltage from the bridge circuit 16 of four load detectors 1, 1, 1 and 1 is normal. If it is discriminated that it is normal, the routine proceeds to Step S3 as “Yes.” On the other hand, if it is discriminated that it is abnormal, the routine proceeds to Step S2 as “No,” and the emergency alarm is given by the alarm means 26.

At step S3, the total value W of the load is calculated based on the output voltage from each bridge circuit 16, 16, 16 and 16. Subsequently, the routine proceed to Step S4. The total value W of the load can be derived from the following formula (i).

W=W1+W2+W3+W4 (i)

In the aforementioned formula (i), each of W1 to W4 is a load corresponding to the output voltage from each bridge circuit 16, 16, 16 and 16, and each can be derived from the following formula. That is, W1=A1×V1+B1, W2=A2×V2+B2, W3=A3×V3+B3, and W4=A4×V4+B4. V1 to V4 are the output voltage from each bridge circuit 16, 16, 16 and 16, respectively. A1 to A4 and B1 to B4 are the values determined beforehand, respectively.

At Step S4, tare processing is performed in the state in which a subject is not occupying the bed 50, and only a subject's load (weight) is measured. Subsequently, the routine proceeds to Step S5.

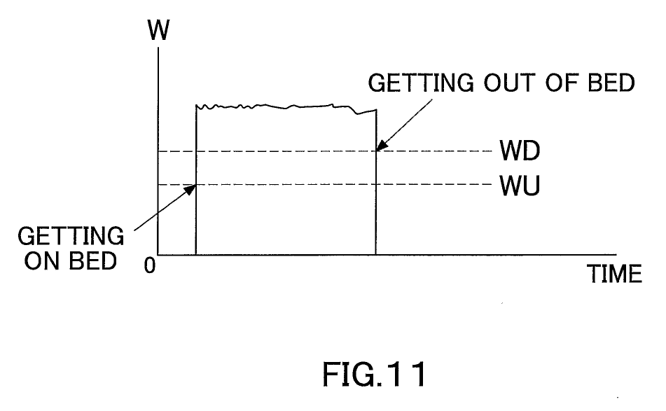

At step S5, it is discriminated whether the total value W of the load exceeds a standard set value WU (hereinafter referred to as “standard set value WU for occupancy discrimination”) by which it is discriminated that the subject is occupying the bed 50. That is, as shown in FIG. 11, when it is discriminated that the total value W of the load exceeds the standard set value WU of the occupancy discrimination (i.e., W≧WU), the routine proceeds to S7 as “Yes,” and it is discriminated that the bed is occupied and predetermined occupancy information is displayed by the display means 25. On the other hand, when it is discriminated that the total value W of the load is under the standard set value WU of the occupancy discrimination (i.e., W<WU), the routine proceeds to Step S6 as “No,” and it is discriminated that the bed is not occupied, and the routine returns to Step S4. The standard set value WU of occupancy discrimination is stored beforehand in a storing portion (not shown) equipped with the operation means 21.

At step S8, it is discriminated whether the total value W of load is below the standard set value WD (hereinafter referred to as “standard set value WD of non-occupancy discrimination”) based on which it is discriminated that the subject who was occupying the bed 50 gets off the bed 50. That is, as shown in FIG. 11, when it is discriminated that the total value W of load is below the standard set value WD of non-occupancy discrimination (i.e., W≦WD), the routine proceeds to Step S9 as “Yes,” and it is discriminated as a non-occupancy. Then, the routine returns to step S4 and proceeds to Step S10. At Step S10, a non-occupancy alarm is given by the alarm means 26. From this alarm, it becomes possible to detect the non-occupancy of the subject or the unexpected falling of a subject from the bed 50. On the other hand, when it is discriminated that the total value W of load exceeds the standard set value WD of non-occupancy discrimination (i.e., W>WD), the routine returns to Step S7 as “No.” The standard set value WD of non-occupancy discrimination is stored in advance in a storing portion equipped in the operation means 21.

The bed load detector 1 of this first embodiment has the following advantages.

Namely, in this load detector 1, the leg disposing plate portion 13 is attached to the tip end portion 7b of the cantilever portion 7 horizontally supported by the base plate portion 2 and the strain gages R1 to R4 as detection sensors are attached to the cantilever portion 7. Therefore, the structure of the load detector 1 can be simplified, which in turn can reduce the height of the leg disposing plate portion 13 of the load detector 1 from the bed installation surface 55. Therefore, in a state in which the caster 51 of the bed 50 is disposed on the leg disposing plate portion 13 of this load detector 1, the height of the bed 50 can be lowered. As a result, the caster 51 of the bed 50 can be easily disposed on the leg disposing plate portion 13 of the load detector 1. Furthermore, the getting off the caster 51 from the leg disposing plate portion 13 or like can be performed easily.

The leg disposing plate portion 13 of the load detector 1 is arranged between the side portions 3 and 3 and the connecting portions 4 and 4 of the base plate portion 2 as seen from the top, and can be displaced downward between the side portions 3 and 3 and the connecting portions 4 and 4 of the base plate portion 2. Thus, no base plate portion 2 exists under the leg disposing plate portion 13, and therefore the height of the leg disposing plate portion 13 can be further lowered.

Furthermore, since the one end portions and the other end portions of the side portions 3 and 3 of the base plate portion 2 are mutually connected by the pair of connecting portions 4 and 4, the base plate portion 2 is high in stability. Therefore, the leg disposing plate portion 13 can be displaced downward correctly.

And since the slope 4a for guiding the caster 51 to the leg disposing plate portion 13 is formed on the predetermined connecting portion 4 of the connecting portions 4 and 4 of the base plate portion 2, at the time of disposing the caster 51 on the leg disposing plate portion 13, the caster 51 can be easily disposed on the leg disposing plate portion 13 by passing on the slope 4a of the connecting portion 4. Furthermore, at the time of getting off the caster 51 from the leg disposing plate portion 13, the caster 51 also can be easily got off from the leg disposing plate portion 13 by passing the slope 4a of the connecting portion 4.

Since the caster fall prevention wall portions 14A, 14B and 14B are formed on the basal end portion and both the side edge portions of the leg disposing plate portion 13 as a caster fall preventing means, respectively, the falling of the cater 51 from the leg disposing plate portion 13 can be prevented certainly.

Furthermore, since the upper surface 13a of the leg disposing plate portion 13 is formed into a slant face of a falling gradient in a direction from the tip end portion of the leg disposing plate portion 13 to the basal end side thereof, the caster 51 disposed on the leg disposing plate portion 13 can move toward the basal end side of the leg disposing plate portion 13. This prevents the falling of the caster 51 from the tip end portion of the leg disposing plate portion 13.

Furthermore, since the lower surface 13b of the leg disposing plate portion 13 is formed into a slant face of a falling gradient in a direction from the tip end portion of the leg disposing plate portion 13 toward the basal end side thereof, the distance “b” of the tip end portion of a leg disposing plate portion 13 from the bed installation surface 55 can be increased. Therefore, the contact of the tip end portion of the leg disposing plate portion 13 to the bed installation surface 55 due to the displacement of the leg disposing plate portion 13 can be prevented effectively.

Furthermore, since the strain gages R1, R2, R3 and R4 as distortion detection sensors are attached to the predetermined position of the cantilever portion 7, the distortion of the cantilever portion 7 can be certainly detected.

Since the output voltage from the bridge circuit 16 including the four strain gages R1, R2, R3 and R4 is used to detect the load of the bed 50, the distortion of the cantilever portion 7 can be detected with high accuracy.

Since the base plate portion 2, the cantilever portion 7 and the leg disposing plate portion 13 are formed by an extruded article, respectively, these can be manufactured in a cost efficient manner.

The bed occupancy detecting apparatus 20 of this embodiment has the following advantages.

Namely, since the occupancy detecting apparatus 20 is equipped with the aforementioned load detector 1, it has the aforementioned advantages of the load detector 1. Since it is equipped with the operation means 21, the display means 25, the alarm means 26, and the communication means 27, it is possible to assuredly discriminate whether a subject is occupying the bed 50, and display the operation result of the operation means 21. In cases where the operation result of the operation means 21 comes outside the set range, for example, when a subject gets off the bed 50 or unexpectedly falls from the bed 50, the non-occupancy or the falling can be notified of a nurse, a care worker, a guard, etc. by an alarm, and whether the subject is occupying the bed 50 can be detected at remote locations.

Furthermore, the bed occupancy detection system according to a first embodiment of the invention is equipped with the load detector 1 of the aforementioned occupancy detecting apparatus 20, the operation means 21, the display means 25, the alarm means 26, and the communication means 27. Therefore, with this monitoring system, the aforementioned advantages of the occupancy detecting apparatus 20 can be obtained and the monitoring whether a subject is occupying the bed 50 can be performed at remote locations.

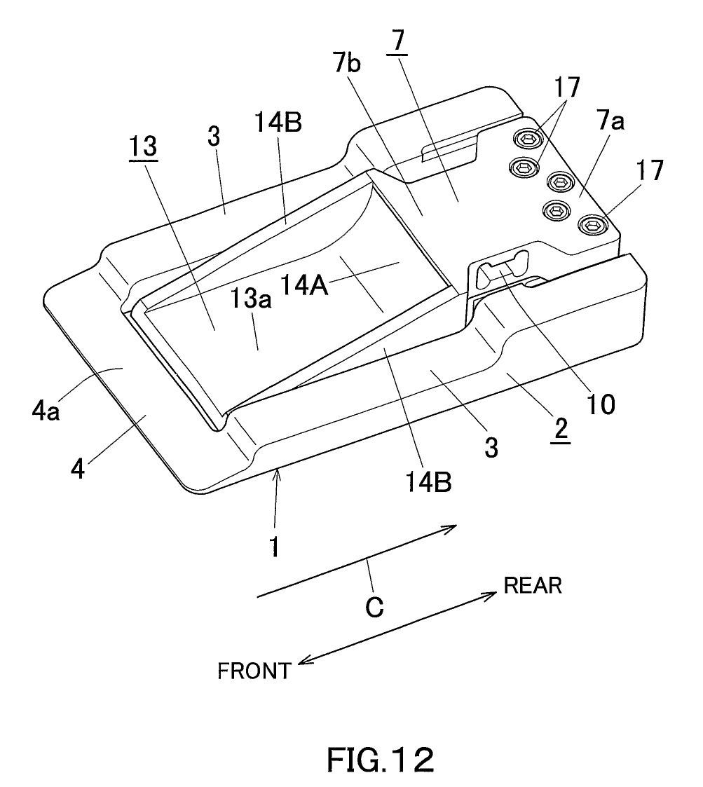

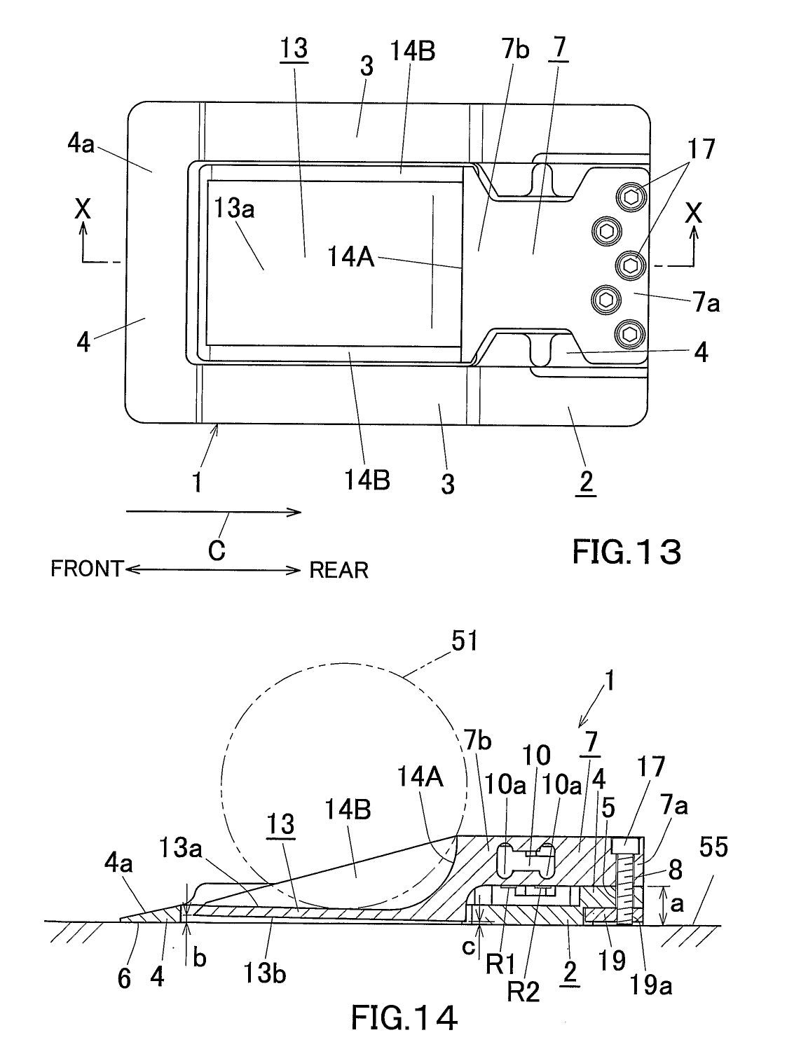

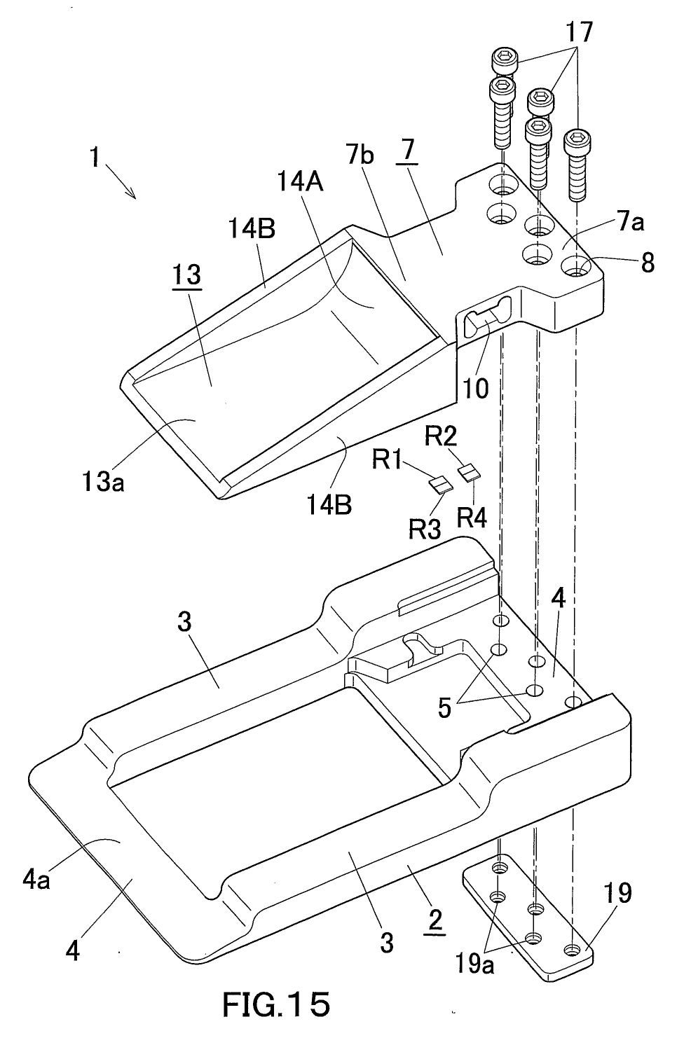

FIGS. 12 to 15 show a bed load detector according to a second embodiment of this invention. In these figures, the same reference numeral is allotted to the same element as the element of the load detector 1 of the aforementioned first embodiment.

In this load detector 1, the cantilever portion 7 and the leg disposing plate portion 13 are integrally formed by aluminum die casting.

The other structure of this load detector 1 is the same as that of the aforementioned first embodiment.

With this load detector 1, since the cantilever portion 7 and the leg disposing plate portion 13 are integrally formed by aluminum die casting, the cantilever portion 7 and the leg disposing plate portion 13 can be manufactured in a cost effective manner, and the connection strength between them can be increased significantly. There also is an advantage that it is not necessary to use any connecting members, such as a screw, for connecting them.

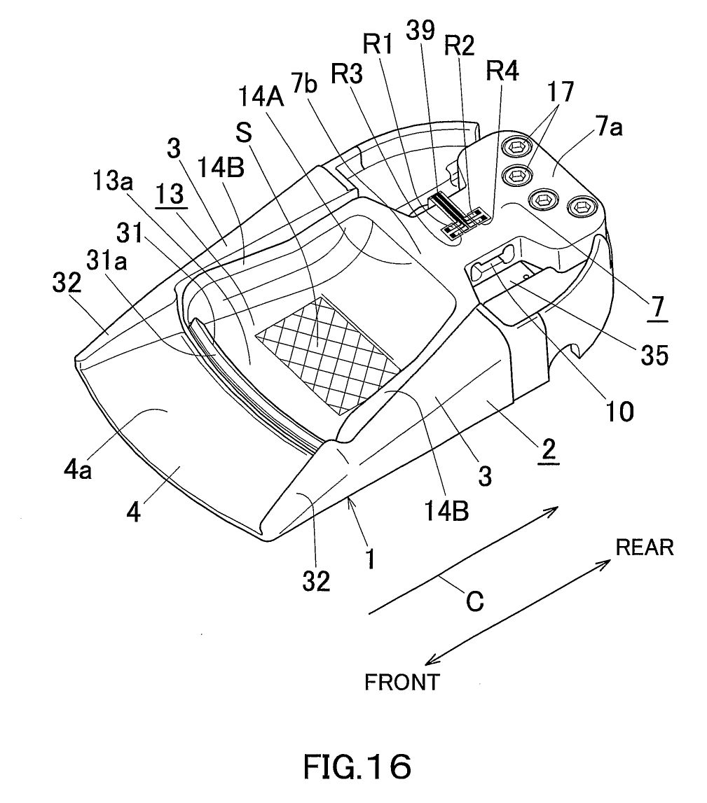

FIGS. 16 to 25 show a bed load detector according to a third embodiment of this invention. In these figures, the same reference numeral is allotted to the same element as the element of the load detector 1 of the aforementioned first embodiment.

In this load detector 1, the cantilever portion 7 and the leg disposing plate portion 13 are integrally formed by aluminum die casting. The leg portion of the bed 50 to be disposed on the leg disposing plate portion 13 is equipped with a bed moving caster 51.

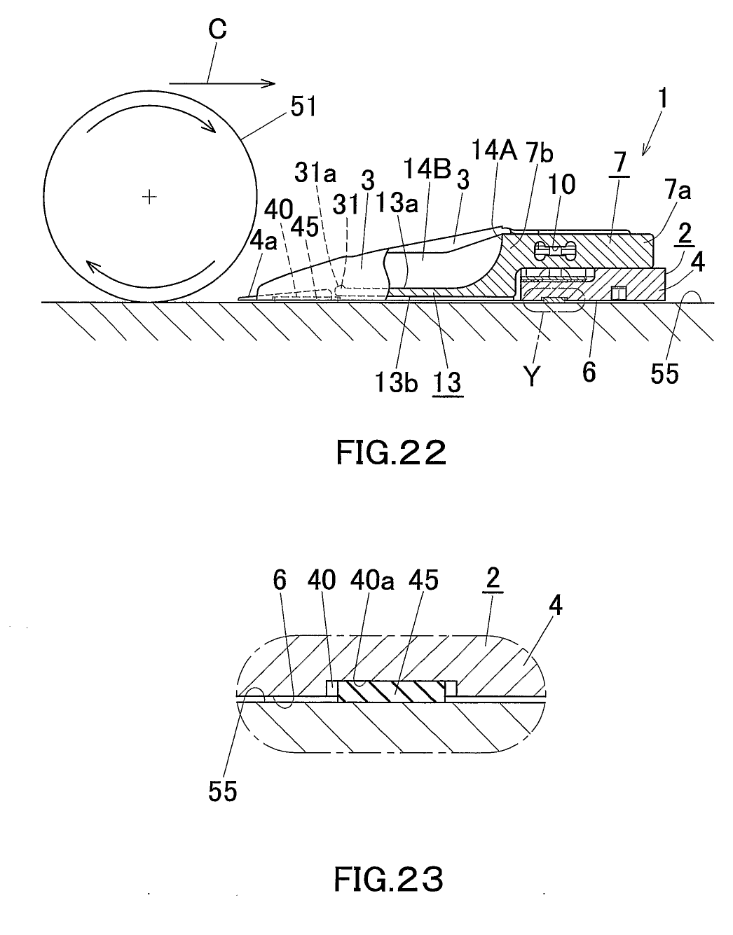

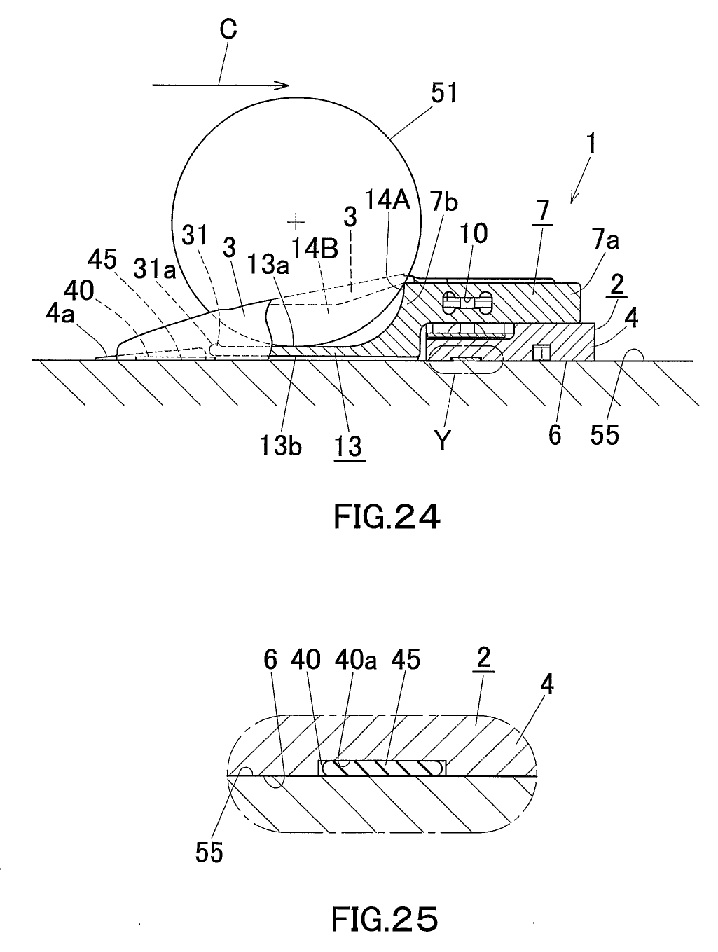

In FIG. 16, the reference letter “S” denotes a regular load detection position (in detail, a regular load detection area) of the upper surface 13a of the leg disposing plate portion 13 in the load detector 1. Furthermore, as mentioned in the first embodiment, the reference letter “C” shows the traveling direction of the caster 51 at the time of disposing the caster 51 from the bed installation surface 55 to the leg disposing plate portion 13 (see FIGS. 22 and 24).

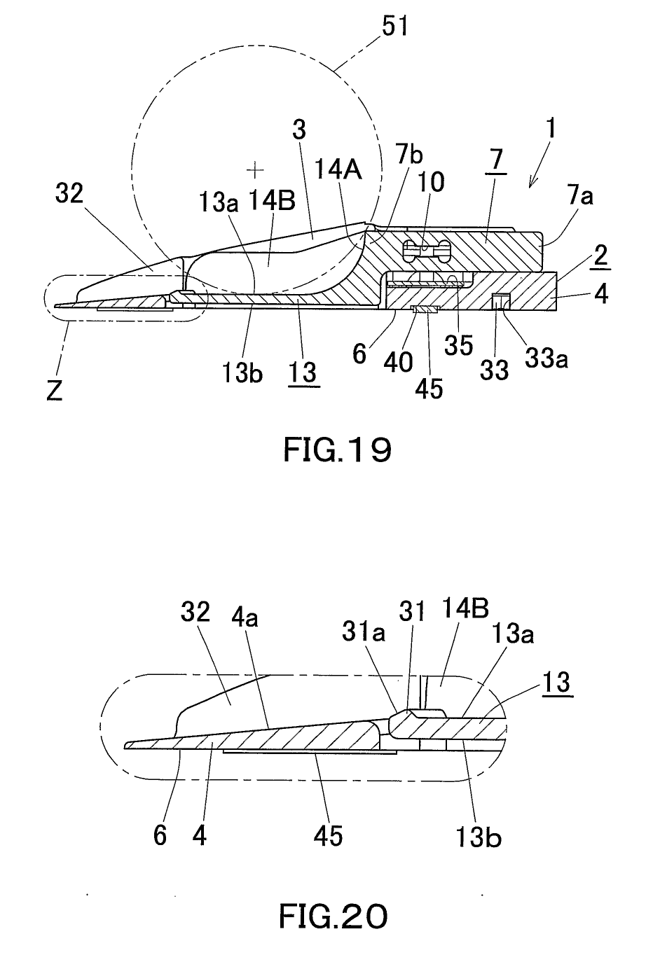

At the basal end portion of the leg disposing plate portion 13, a stopper wall portion 14A integrally protruded upwardly with respect to the upper surface 13a of the leg disposing plate portion 13 is provided. The stopper wall portion 14A is designed to stop the travel of the caster 51 which arrived at the regular load detection position S on the leg disposing plate portion 13 from the bed installation surface 55. This stopper wall portion 14A also functions as a caster fall prevention wall portion (i.e., leg portion fall preventing wall portion) which prevents the falling of the caster 51 from the leg disposing plate portion 13. Therefore, this stopper wall portion 14A can also be regarded as a caster fall prevention wall portion (leg portion fall preventing wall portion). The cross-sectional shape of this stopper wall portion 14a is a generally circular shape as shown in FIG. 19.

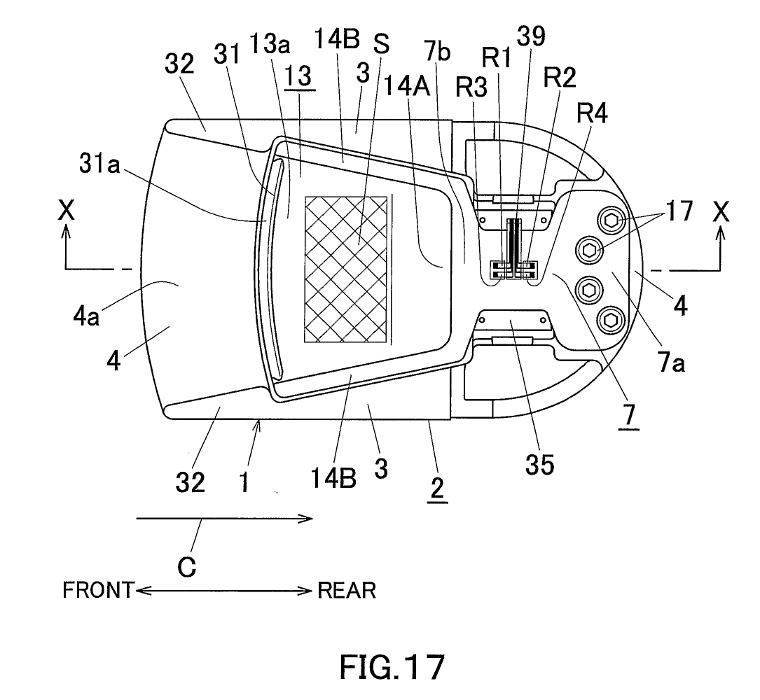

Furthermore, at both side edge portions of the leg disposing plate portion 13, as caster fall preventing means (i.e., leg portion fall preventing means), a pair of caster fall prevention wall portions 14B and 14B (i.e., leg portion fall preventing wall portions) upwardly protruded with respect to the upper surface 13a of the leg disposing plate portion 13 is integrally formed. In this third embodiment, as shown in FIG. 17, both the caster fall prevention wall portions 14B and 14B are integrally formed in such a manner that the distance therebetween gradually increases in a direction opposite to the traveling direction C of the caster 51, in other words, the distance therebetween gradually decreases in the traveling direction C of the caster 51. The distance between the rear end portions of both the caster fall prevention wall portions 14B and 14B is set so as to fall within the range of 70 to 100 mm, and the distance between the front end portions of both the caster fall prevention wall portions 14B and 14B is set so as to fall within the range of 120 to 200 mm. It should be understood that in this invention, however, the distance between the front end portions of both the caster fall prevention wall portions 14B and 14B and the distance between the rear end portions are not limited to the above.

Further, as shown in FIG. 16, at the tip end portion of the upper surface 13a of the leg disposing plate portion 13, a convex ridge portion 31 over which the caster 51 can climb is integrally formed. The convex ridge portion 31 is formed into a triangular shape or a reverse V shape in cross-section. Whereby, the caster 51 can be disposed on the regular load detection position S of the leg disposing plate portion 13 by climbing over the convex ridge portion 31.

The projection height of this convex ridge portion 31 with respect to the upper surface 13a of the leg disposing plate portion 13 is set so as to fall within the range of 2 to 6 mm. As shown in FIG. 20, the front face 31a of this convex ridge portion 31 is formed into a slant face of a rising gradient larger than the gradient of the slope 4a in the traveling direction C of the caster 51. The gradient of the front face 31a of this convex ridge portion 31 with respect to the bed installation surface 55 is preferably set so as to fall within the range of 10 to 20°. As mentioned above, the gradient of the slope 4a with respect to the bed installation surface 55 is preferably set so as to fall within the range of 2 to 10°, more preferably 2 to 6°. The height position of the upper end of the slope 4a is set to the same or approximately the same as the height position of the tip end portion of the leg disposing plate portion 13. It should be understood that in this invention, however, the projection height of the convex ridge portion 31 and the gradient of the front face 31a of the convex ridge portion 31 are not limited to the above.

The convex ridge portion 31 has also played the role of a beam for controlling the bending of the leg disposing plate portion 13. Thus, the detection accuracy of load can be improved and the thickness of the leg disposing plate portion 13 can be decreased, resulting in a weight saved load detector 1.

At both side edge portions of the slope 4a of the connecting portion 4 of the base plate portion 2, as shown in FIGS. 16 and 17, a pair of guide wall portions 32 and 32 protruded upwardly with respect to the slope 4a for guiding a caster 51 in a direction from the bed installation surface 55 toward the leg disposing plate portion 13 are provided. In this third embodiment, these guide wall portions 32 and 32 are integrally formed on the slope 4a in a state in which the distance thereof gradually decreases in the traveling direction C of the caster 51, in other words, the distance gradually increases in a direction opposite to the traveling direction C of the caster 51. Furthermore, the rear end portions of both the guide wall portions 32 and 32 are arranged at the positions corresponding to the front end portions of both the caster fall prevention wall portions 14B and 14B. In detail, as shown in FIG. 17, both guide wall portions 32 and 32 are arranged along the virtual lines (in detail, virtual straight lines) forwardly extended along the caster fall prevention wall portions 14B an 14B as seen from the top.

Four strain gages R1, R2, R3 and R4 as distortion detection sensors are bonded to the upper position of the hollow pore 10 of the upper surface of the cantilever portion 7 with adhesive. These four strain gages R1, R2, R3 and R4 are electrically connected as shown in FIG. 8 to form a Wheatstone bridge circuit 16.

Furthermore, the load detector 1 of this third embodiment is equipped with a control board 35 mounting a controller, etc. To this control board 35, an input signal line (in detail, an input-voltage line) and an output signal line (in detail, an output voltage line) 39 of the bridge circuit 16 including the strain gages R1, R2, R3 and R4 are electrically connected.

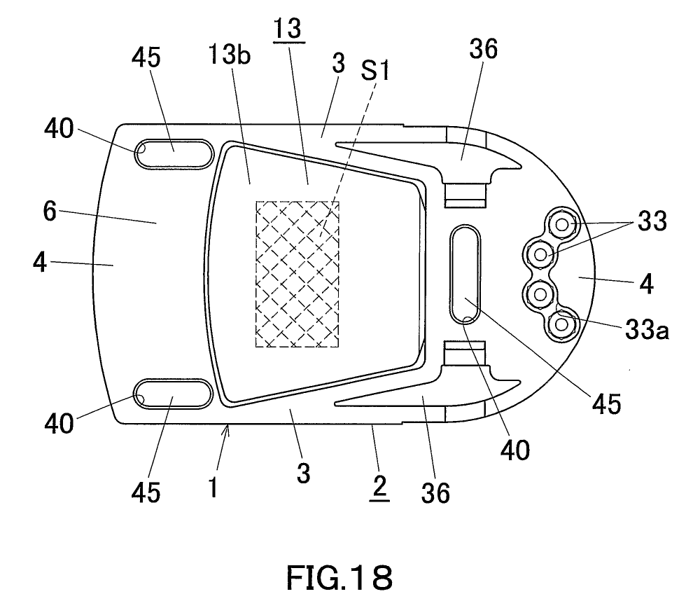

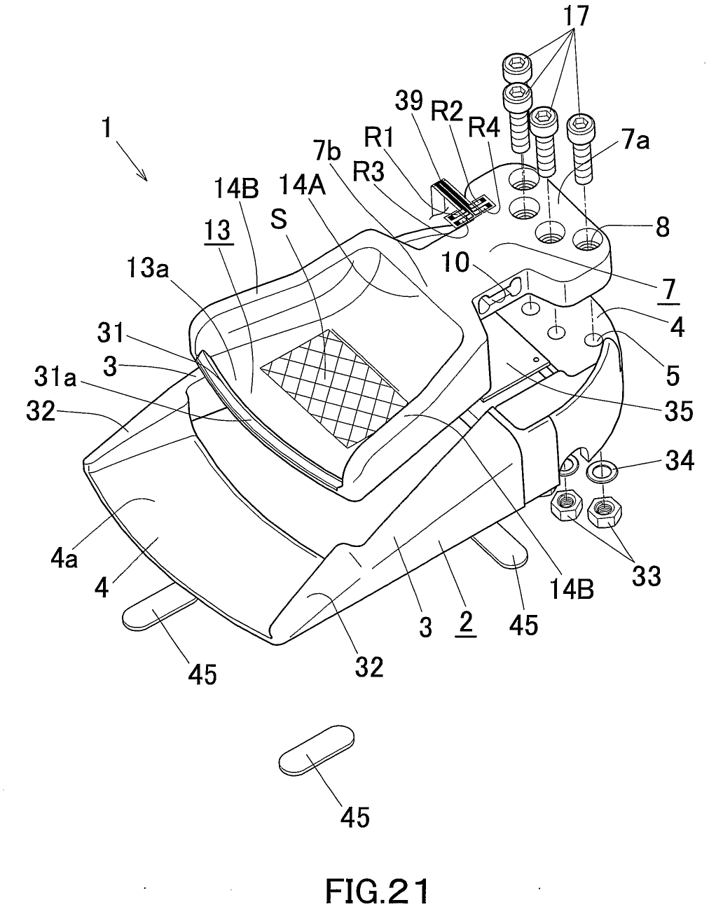

In FIG. 21, the reference numerals “33” and “34,” denote a nut and washer engaged with a cantilever portion fixing bolt 17. In FIG. 18, the reference numeral “33a” denotes a dented portion formed in the lower surface of the connecting portion 4 of the base plate portion 2 for accommodating nuts 33. And, the reference numeral “36” denotes a concave portion formed in the lower surface of the base plate portion 2 for reducing the weight of the load detector 1.

As shown in FIGS. 18, 22 and 23, at three portions surrounding the immediately below position S1 of the regular load detection position S on the leg disposing plate portion 13 in the floor contacting face 6 which comes into contact with the bed installation surface 55 of the base plate portion 2 of the load detector 1, a dented portion 40 of an ellipse shape as seen from the bottom is formed, respectively.

In each dented portion 40, an elastic nonslip member 45 made of an elastic rubber sheet is disposed so as to protrude downwardly from the floor contacting face 6 as shown in FIG. 23. In this third embodiment, the nonslip member 45 is disposed in the dented portion 40 and bonded to the ceiling face 40a of the dented portion 40. This nonslip member 45 prevents the load detector 1 from unexpectedly sliding on the bed installation surface 55. This nonslip member 45 is made of rubber such as natural rubber or silicone rubber.

As shown in FIGS. 22 and 23, in a state in which the load detector 1 is disposed on the bed installation surface 55, the load detector 1 is configured such that the floor contacting face 6 is slightly raised upwardly from the bed installation surface 55 by being supported by the nonslip member 45 when a caster 51 of a bed is not disposed on the leg disposing plate portion 13. In this state, the gap between the floor contacting face 6 and the bed installation surface 55 is preferably set so as to fall within the range of 0.2 to 2 mm. It should be understood that in this invention, however, the gap is not limited to the aforementioned range.

Furthermore, as shown in FIGS. 24 and 25, in a state in which this load detector 1 is disposed on the bed installation surface 55, the load detector 1 is configured such that, when the caster 51 of the bed is disposed on the leg disposing plate portion 13, the nonslip member 45 is compressed by the load from the caster 51 of the bed between the ceiling face 40a of the dented portion 40 and the bed installation surface 55 and the floor contacting face 6 comes into contact with (in detail, pressure-contact with) the bed installation surface 55.

The size of the nonslip member 45 is preferably set so as to fall within the range of 10 to 40 mm in length (e.g., 28 mm), 5 to 30 mm in width (e.g., 8 mm), 0.5 to 6 mm in thickness (e.g., 2 mm).

The size of the dented portion 40 is preferably set so as to fall within the range of 12 to 42 mm in length (e.g., 30 mm), 7 to 32 mm in width (e.g., 10 mm), 0.3 to 4 mm in depth (e.g., 1.8 mm).

Furthermore, the size of the dented portion 40 is set so that the dented portion 40 can accommodate the entire nonslip member 45 in the state in which the nonslip member 45 is compressed between the ceiling face 40a of the dented portion 40 and the bed installation surface 55 as shown in FIG. 25.

In this invention, however, the size of the nonslip member 45 and the size of the dented portion 40 are not limited to the aforementioned ranges.

In this invention, the number of the dented portion 40 is not limited to three. For example, it can be configured such that four, five or more dented portions 40 are formed in the floor contacting face 6 so as to surround the immediately below position S1 of the regular load detection position S of the leg disposing plate portion 13 and the nonslip member 6 is disposed in each dented portion 40.

Next, the method of usage of the load detector of the third embodiment will be explained below.

As shown in FIG. 22, the load detectors 1 are disposed on the bed installation surface 55 at a distance corresponding to the pitch of the casters 51 as the leg portion of the bed.

In this state, as shown in FIG. 23, in each load detector 1, the floor contacting face 6 is raised slightly upward with respect to the bed installation surface 55 by being supported by three nonslip members 45, 45 and 45. Therefore, in this state, in the load detector 1, only the three nonslip members 45, 45 and 45 are in contact with the bed installation surface 55. Namely, the load detector 1 is supported by only three nonslip members 45, 45 and 45.

Subsequently, a person who moves the bed (i.e., bed installation worker) (not shown) pushes the bed so that each caster 51 of the bed travels on the slope 4a from the bed installation surface 55 toward the leg disposing plate portion 13 of the corresponding load detector 1 and then climbs over the convex ridge portion 31.

By climbing over the convex ridge portion 31, as shown in FIG. 24, the caster 51 is disposed at the regular load detection position S on the leg disposing plate portion 13. By the moment caused by climbing the convex ridge portion 31 and the action of the gravity due to the inclination of the upper surface 13a of the leg disposing plate portion 13, the caster 51 slightly runs on the leg disposing plate portion 13 toward the stopper wall portion 14A and abuts against the stopper wall portion 14A. Thereby, the movement of the caster 51 is prevented, and therefore the caster 51 is disposed at the regular load detection position S on the leg disposing plate portion 13 with the caster abutted against the stopper wall portion 14A.

In this state, as shown in FIG. 25, the nonslip member 45 is compressed downward by the load from the caster 51 of the bed between the ceiling face 40a of the dented portion 40 and the bed installation surface 55. As a result of that the thickness decreases, the floor contacting face 6 is brought into contact with (in detail, pressure-contact with) the bed installation surface 55. At this time, the entire nonslip member 45 is accommodated in the dented portion 40 in the compressed state as mentioned above.

In accordance with the aforementioned steps, the caster 51 of the bed is disposed on the leg disposing plate portion 13 of the load detector 1. The operation of getting down from the leg disposing plate portion 13 of the load detector 1 onto the bed installation surface 55 can be performed by the steps opposite to the steps mentioned above.

The bed occupancy detection method using this load detector 1 is the same as that of the aforementioned first embodiment, and therefore the explanation is omitted.

The load detector 1 of this third embodiment has the same advantages as those of the load detector of the aforementioned first embodiment and also has the following advantages.

In this load detector 1, a pair of caster fall prevention wall portions 14B and 14B are formed at the side edge portions of the leg disposing plate portion 13 such that the distance between the caster fall prevention wall portions 14B and 14B increases in the direction opposite to the traveling direction C of the caster 51. Therefore, at the time of disposing the caster 51 on the leg disposing plate portion 13 from the bed installation surface 55, the falling of the caster 51 from the leg disposing plate portion 13 can be prevented. Furthermore, the caster 51 can be easily disposed between the caster fall prevention wall portions 14B and 14B on the leg disposing plate portion 13, thereby enabling an easy installation of the caster 51. Even if the caster 51 comes into contact with the caster fall prevention wall portion 14B in the middle of installation actuation of the caster 51 on the leg disposing plate portion 13, the caster 51 can be guided in the direction toward the stopper wall portion 14A along with the caster fall prevention wall portion 14B.

Furthermore, since the stopper wall portion 14A which stops the travel of the caster 51 which arrived at the regular load detection position S on the leg disposing plate portion 13 is formed at the basal end portion of the leg disposing plate portion 13, the caster 51 can be certainly disposed at the regular load detection position S on the leg disposing plate portion 13. Therefore, the deterioration of the detection accuracy of load can be prevented due to the placement of the caster 51 on a position away from the regular load detection positions on the leg disposing plate portion 13.

Furthermore, a pair of guide wall portions 32 and 32 are formed at both side edge portions of the slope 4a of the connecting portion 4 of the base plate portion 2 so that the distance therebetween becomes narrower in the traveling direction C of the caster 51. Therefore, when the caster 51 runs on the slope 4a, even if the caster 51 comes into contact with the guide wall portion 32, the caster 51 is guided in the direction toward the leg disposing plate portion 13 by the guide wall portion 32, and therefore the installation of the caster 51 can be performed more easily.

Furthermore, the convex ridge portion 31 is formed at the tip end portion of the upper surface of the leg disposing plate portion 13 along the tip end portion, and when the caster 51 climbs over this convex ridge portion 31, the caster 51 can be disposed at the regular load detection position S on the leg disposing plate portion 13. Therefore, the caster 51 can be certainly disposed at the regular load detection position S on the leg disposing plate portion 13. Furthermore, the unexpected falling of the caster 51 disposed on the leg disposing plate portion 13 from the tip end portion of the leg disposing plate portion 13 can be prevented by this convex ridge portion 31.

Furthermore, since this convex ridge portion 31 also functions as a beam for restraining the bending of the leg disposing plate portion 13, the detection accuracy can be improved, and the thickness of the leg disposing plate portion 13 can be decreased.

Furthermore, the front face 31a of this convex ridge portion 31 is formed into a slant face of a rising gradient larger than the gradient of the slope 4a in the traveling direction C of the caster 51. Therefore, as to whether the caster 51 climbed over the convex ridge portion 31 from the slope 4a, namely, whether the caster 51 is disposed at the regular load detection position S on a leg disposing plate portion 13, a person who moves the bed can discriminate easily based on the force for pushing the bed.

Furthermore, this load detector 1 is configured such that in the state in which it is disposed on the bed installation surface 55, when the caster 51 of the bed is not disposed on the leg disposing plate portion 13, the floor contacting face 6 is raised upward with respect to the bed installation surface 55 by being supported by the nonslip member 45. Therefore, at the time of disposing the caster 51 of the bed on the leg disposing plate portion 13, the slip of the load detector 1 on the bed installation surface 55 can be prevented by the nonslip member 45. Therefore, the installation operation of the caster 51 can be performed more easily.

Furthermore, this load detector 1 is configured such that when the caster 51 of the bed is disposed on the leg disposing plate portion 13, the nonslip member 45 is compressed by the load from the caster 51 of the bed between the ceiling face 40a of the dented portion 40 and the bed installation surface 55, and therefore the floor contacting face 6 comes into contact with the bed installation surface 55. Therefore, the deterioration of the detection accuracy of the load due to the influence of the nonslip member 45 can be prevented. Furthermore, since the force of pressing the nonslip member 45 against the bed installation surface 55 is decreased, even if the nonslip member 45 is made of rubber, the adhesion of the nonslip member 45 to the bed installation surface 55 can be restrained. Therefore, when the load detector 1 becomes unnecessary, the load detector 1 can be easily removed from the bed installation surface 55.

Furthermore, dented portions 40 are formed at three portions on the floor contacting face 6 of the load detector 1 surrounding the immediately below the regular load detection position S on the leg disposing plate portion 13, and the nonslip member 45 is disposed in each dented portion 40. Therefore, the stability of the load detector 1 can be improved in the state in which the caster 51 of the bed is disposed at the regular load detection position S on the leg disposing plate portion 13.

Furthermore, the size of the dented portion 40 is set such that the dented portion 40 can accommodate the entire nonslip member 45 in the state in which the nonslip member 45 is compressed between the ceiling face 40a of the dented portion 40 and the bed installation surface 55. Therefore, when the nonslip member 45 is compressed, this nonslip member 45 can be certainly accommodated in the dented portion 40. Consequently, in the state in which the caster 51 of the bed is disposed on the leg disposing plate portion 13, the floor contacting face 6 can be brought into contact with the bed installation surface 55 assuredly.

Furthermore, since the nonslip member 6 is a product made of rubber, it can be obtained at low cost, which in turn can reduce the manufacturing cost of the load detector 1.

Although some embodiments of this invention were explained above, it should be understood that the present invention is not limited to the aforementioned embodiments, and various modification can be performed.

For example, although the base plate portion 2 of the load detector 1 is formed into a rectangular shape as seen from the top, in the present invention, the base plate portion 2 can be formed into a generally U shape as seen from the top having a pair of side portions 3 and 3 opposed at a distance and a connecting portion 4 arranged between the side portions 3 and 3 and connecting the one end portions of the side portions 3 and 3.

Furthermore, in this invention, the material of the base plate portion 2, the cantilever portion 7 and the leg disposing plate portion 13 can be, for example, metals (e.g., stainless steel) other than aluminum, or plastic, such as, e.g., fiber-reinforced plastic.

Furthermore, in this invention, the cantilever portion 7 and the leg disposing plate portion 13 can be integrally formed by aluminum die casting, and the base plate portion 2, the cantilever portion 7 and the leg disposing plate portion 13 can be integrally formed by aluminum die casting.

In this invention, as an attaching means of the strain gages R1 to R4 to the cantilever portion 7, it is not limited to adhesive. In place of adhesive, the attaching can be performed by caulking, screw fixing, rivet fixing, welding (e.g., spot welding), brazing, etc.

In this invention, only one strain gage as a distortion detection sensor can be attached to the cantilever portion 7, or two or more strain gages can be attached to the cantilever portion 7. In the aforementioned embodiment a bridge circuit 16 includes four strain gages R1, R2, R3 and R4. In this invention, however, five, six or more strain gages can be used. Alternatively, one or more strain gages and one or more fixed resistors (dummy resistors) can be used.

In this invention, the distortion detection sensor can be any sensor other than a strain gage. For example, the sensor can be an electric conduction elastomer sensor (a conducting-rubber sensor, conductive resin sensor, etc.), an electrostriction device sensor, a magnetostriction device sensor, or one or more sensors selected from the group including the aforementioned sensors.

Furthermore, in this invention, it is not necessary that a leg portion of a bed 50 is provided with a bed moving caster.

### INDUSTRIAL APPLICABILITY

The present invention can be utilized in a bed load sensor, a bed occupancy detection apparatus for detecting whether a subject is occupying a bed, a bed occupancy detection method, and a bed occupancy monitoring system.

While the present invention may be embodied in many different forms, a number of illustrative embodiments are described herein with the understanding that the present disclosure is to be considered as providing examples of the principles of the invention and such examples are not intended to limit the invention to preferred embodiments described herein and/or illustrated herein.

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims are to be interpreted broadly based on the language employed in the claims an not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, feature, process or step, any combination thereof, and/or any portion thereof, etc. In some examples, various embodiments may include overlapping features. In this disclosure and during the prosecution of this case, the following abbreviated terminology may be employed: “e.g.” which means “for example;” and “NB” which means “note well.”

1. A bed load detector, comprising:
a base plate portion to be disposed on a bed installation surface;
a cantilever portion supported approximately horizontally by the base plate portion in a state in which the cantilever portion is located at a distance above the bed installation surface;
a leg disposing plate portion on which a leg portion of a bed is disposed, the leg disposing plate portion being provided at a tip end portion of the cantilever portion; and
a distortion detection sensor configured to detect distortion of the cantilever portion and output a signal to be used for detection of a bed load.

2. The bed load detector as recited in claim 1, wherein
the base plate portion includes a pair of side portions arranged in an opposed manner at a certain distance and a connecting portion arranged between both the side portions and mutually connecting one end portions of both the side portions, and
wherein the cantilever portion is supported by the connecting portion so that the leg disposing plate portion can be displaced downwardly between both the side portions.

3. The bed load detector as recited in claim 1, wherein
the base plate portion includes a pair of side portions arranged in an opposed manner at a certain distance and a pair of connecting portions arranged in an opposed manner at a certain distance and mutually connecting one end portions of the side portions and the other end portions of the side portions respectively, and
wherein the cantilever portion is supported by one of the connecting portions so that the leg disposing plate portion can be displaced downwardly between the side portions and the connecting portions.

4. The bed load detector as recited in claim 3, wherein
the leg portion of the bed is provided with a bed moving caster, and
wherein a slope for guiding the caster from the bed installation surface to the leg disposing plate portion is formed on the other of the connecting portions.

5. The bed load detector as recited in claim 1, wherein the leg disposing plate portion is provided with a leg portion fall preventing means for preventing a fall of the leg portion of the bed from the leg disposing plate portion.

6. The bed load detector as recited in claim 5, wherein a leg portion fall preventing wall portion upwardly protruded with respect to an upper surface of the leg disposing plate portion is provided at a basal end portion of the leg disposing plate portion as the leg portion fall preventing means.

7. The bed load detector as recited in claim 5, wherein
a pair of leg portion fall preventing wall portions upwardly protruded with respect to an upper surface of the leg disposing plate portion are provided at both side edge portions of the leg disposing plate portion as the leg portion fall preventing means.

8. The bed load detector as recited in claim 7, wherein
the leg portion of the bed is provided with a bed moving caster, and
wherein a convex ridge portion that the caster can climb over is provided along a tip end portion of the upper surface of the leg disposing plate portion so that the caster is positioned at a regular load detection position on the leg disposing plate portion by climbing over the convex ridge portion.

9. The bed load detector as recited in claim 4, wherein a leg portion fall preventing wall portion upwardly protruded with respect to an upper surface of the leg disposing plate portion is provided at a basal end portion of the leg disposing plate portion as a means for preventing a fall of the caster from the leg disposing plate portion,
wherein a pair of leg portion fall preventing wall portions upwardly protruded with respect to an upper surface of the leg disposing plate portion are provided at both side edge portions of the leg disposing plate portion as a means for preventing a fall of the caster from the leg disposing plate portion,
wherein a convex ridge portion that the caster can climb over is provided along a tip end portion of the upper surface of the leg disposing plate portion so that the caster is positioned at a regular load detection position on the leg disposing plate portion by climbing over the convex ridge portion, and
wherein a front face of the convex ridge portion is formed into a slant face of a rising gradient larger than a gradient of the slope formed on the other of the connecting portions in a traveling direction of the caster at the time of disposing the caster from the bed installation surface onto the leg disposing plate portion.

10. The bed load detector as recited in claim 3, wherein the leg portion of the bed is provided with a bed moving caster,
wherein a pair of caster fall prevention wall portions protruded upwardly with respect to the upper surface of the leg disposing plate portion are provided at both side edge portions of the leg disposing plate portion as a means for preventing a fall of the caster from the leg disposing plate portion so that a distance of the caster fall prevention wall portions increases in a direction opposite to a traveling direction of the caster at the time of disposing the caster from the bed installation surface onto the leg disposing plate portion, and
wherein a stopper wall portion upwardly protruded with respect to the upper surface of the leg disposing plate portion for stopping a travel of the caster which arrived at a regular load detection position on the leg disposing plate portion is provided at a basal end portion of the leg disposing plate portion.

11. The bed load detector as recited in claim 10, wherein a slope for guiding the caster from the bed installation surface to the leg disposing plate portion is formed on the other of the connecting portions.

12. The bed load detector as recited in claim 10, wherein a convex ridge portion that the caster can climb over is provided along a tip end portion of the upper surface of the leg disposing plate portion so that the caster is positioned at the regular load detection position on the leg disposing plate portion by climbing over the convex ridge portion.

13. The bed load detector as recited in claim 11, wherein a convex ridge portion that the caster can climb over is provided along a tip end portion of the upper surface of the leg disposing plate portion so that the caster is positioned at the regular load detection position on the leg disposing plate portion by climbing over the convex ridge portion, and
wherein a front face of the convex ridge portion is formed into a slant face of a rising gradient larger than a gradient of the slope formed on the other of the connecting portions in a traveling direction of the caster at the time of disposing the caster from the bed installation surface onto the leg disposing plate portion.

14. The bed load detector as recited in claim 1, wherein at least tip end portion of the upper surface of the leg disposing plate portion is formed into a slant face of a falling gradient in a direction from the tip end portion of the leg disposing plate portion toward the basal end side thereof.

15. The bed load detector as recited in claim 1, wherein at least tip end portion of a lower surface of the leg disposing plate portion is formed into a slant face of a falling gradient in a direction from the tip end portion of the leg disposing plate portion toward the basal end side thereof.

16. The bed load detector as recited in claim 1, wherein an elastic nonslip member is disposed in a dented portion formed in a floor contacting face which comes into contact with the bed installation surface with the nonslip member protruded downwardly from the floor contacting face, and
wherein, in a state in which the nonslip member is disposed on the bed installation surface,
when the leg portion of the bed is not disposed on the leg disposing plate portion, the floor contacting face is raised from the bed installation surface at a distance by being supported by the nonslip member,
while when the leg portion of the bed is disposed on the leg disposing plate portion, the nonslip member is compressed between a ceiling surface of the dented portion and the bed installation surface by a load from the leg portion of the bed and the floor contacting face comes into contact with the bed installation surface.

17. The bed load detector as recited in claim 16, wherein the dented portion is formed at three or more portions surrounding a portion immediately below a regular load detection position on the leg disposing plate portion in the floor contacting face, respectively, and wherein the nonslip member is disposed in each of the dented portions.

18. The bed load detector as recited in claim 16, wherein a size of the dented portion is set so that the dented portion can accommodate the entirety of the nonslip member in a condition in which the nonslip member is compressed between the ceiling face of the dented portion and the bed installation surface.

19. The bed load detector as recited in claim 16, wherein the nonslip member is made of rubber.

20. The bed load detector as recited in claim 1, wherein a strain gage is equipped to the cantilever portion as the distortion detection sensor.

21. The bed load detector as recited in claim 20, wherein an electric output from a bridge circuit including the strain gage is used to detect a bed load.

22. The bed load detector as recited in claim 1, wherein at least one of the base plate portion, the cantilever portion and the leg disposing plate portions is an extruded article.

23. The bed load detector as recited in claim 1, wherein at least two of the base plate portion, the cantilever portion and the leg disposing plate portions are integrally formed by aluminum die casting.

24. A bed occupancy detecting apparatus, comprising:
the bed load detector as recited in claim 1; and
an operation means configured to calculate whether a subject is occupying a bed based on an output signal from the distortion detection sensor of the bed load detector.

25. The bed occupancy detecting apparatus as recited in claim 24, further comprising a display means for displaying an operation result of the operation means.

26. The bed occupancy detecting apparatus as recited in claim 24, further comprising an alarm means for giving an alarm based on an operation result of the operation means.

27. The bed occupancy detecting apparatus as recited in claim 24, further comprising a communication means for transmitting an operation result by the operation means.

28. A bed occupancy detecting method, comprising:
disposing the bed load detector as recited in claim 1 on a bed installation surface;
disposing a leg portion of a bed on the leg disposing plate portion of the load detector; and
in this condition, detecting whether a subject is occupying the bed using an output signal from the distortion detection sensor of the bed load detector.

29. A bed occupancy monitoring system, comprising:
the bed load detector as recited in claim 1;
an operation means for calculating whether a subject is occupying the bed based on an output signal from the distortion detection sensor of the bed load detector;
a display means for displaying an operation result of the operation means;
an alarm means for giving an alarm based on an operation result of the operation means; and
a communication means for transmitting the operation result of the operation means.
